(19) United States
(12) Patent Application Publication
(10) Pub. No.: US 2024/0410600 A1
(43) Pub. Date: Dec. 12, 2024

(54) DEHUMIDIFIER

(71) Applicant: Hisense (Guangdong) Air Conditioning Co., Ltd., Jiangmen (CN)

(72) Inventors: Peipei MA, Jiangmen (CN); Kangsheng YANG, Jiangmen (CN)

(73) Assignee: Hisense (Guangdong) Air Conditioning Co., Ltd., Jiangmen (CN)

(21) Appl. No.: 18/811,185

(22) Filed: Aug. 21, 2024

Related U.S. Application Data
(63) Continuation of application No. PCT/CN2023/091691, filed on Apr. 28, 2023.

(30) Foreign Application Priority Data
Apr. 28, 2022 (CN) 202221011956.8
Apr. 28, 2022 (CN) 202221017927.2
Apr. 28, 2022 (CN) 202221017928.7
Apr. 28, 2022 (CN) 202221017929.1

(51) Int. Cl. F24F 1/0083; B01D 53/26; F24F 1/0063

(52) U.S. Cl. CPC F24F 1/0083; B01D 53/265; F24F 1/0063; B01D 2257/80; B01D 2258/06

(57) ABSTRACT

A dehumidifier includes a housing, an evaporator, a condenser, a liquid condensing device, and a fan. The evaporator and the condenser are arranged in sequence in a first direction. A plurality of liquid condensing pipes in the liquid condensing device extend in a second direction, are communicated with a second air channel, and are located in a first region, a second region, and a third region. The first region, the second region, and the third region are arranged in sequence in a third direction. The first direction, the second direction, and the third direction are perpendicular to each other. A contact area between the liquid condensing pipes in the second region and air in a first air channel is greater than contact areas between the air in the first air channel and the liquid condensing pipes in the first region and the third region.

### CROSS-REFERENCE TO RELATED APPLICATIONS

This application is a continuation application of International Patent Application No. PCT/CN2023/091691, filed on Apr. 28, 2023, which claims priority to Chinese Patent Application No. 202221017929.1, filed on Apr. 28, 2022; Chinese Patent Application No. 202221017928.7, filed on Apr. 28, 2022; Chinese Patent Application No. 202221017927.2, filed on Apr. 28, 2022; and Chinese Patent Application No. 202221011956.8, filed on Apr. 28, 2022, which are incorporated herein by reference in their entireties.

### TECHNICAL FIELD

The present disclosure relates to the field of air conditioning technologies and, in particular, to a dehumidifier.

### BACKGROUND

With the progress of science and technology and the improvement of living standards of people, dehumidifiers have gradually entered life of people and become common appliances in work and life of people. Generally, after humid air enters the dehumidifier, the dehumidifier performs heat exchange with humid air through a heat exchanger, so that moisture in the air condenses into condensed water and the air is dried. The air is discharged from the dehumidifier after being dried, so as to achieve the dehumidification effect.

### SUMMARY

In an aspect, a dehumidifier is provided. The dehumidifier includes a housing, an evaporator, a condenser, a liquid condensing device, and a fan. A first air channel and a second air channel are disposed in the housing. The evaporator is disposed in the housing. The condenser is disposed in the housing. The evaporator and the condenser are arranged in sequence in a first direction and located in the first air channel. The liquid condensing device is disposed in the housing and located between the evaporator and the condenser. The liquid condensing device includes a plurality of liquid condensing pipes. The plurality of liquid condensing pipes extend in a second direction and are communicated with the second air channel. The plurality of liquid condensing pipes are located in a first region, a second region, and a third region. The first region, the second region, and the third region are arranged in sequence in a third direction. The first direction, the second direction, and the third direction are perpendicular to each other. A contact area between two or more liquid condensing pipes in the second region and air in the first air channel is greater than a contact area between two or more liquid condensing pipes in the first region and the air in the first air channel, and the contact area between two or more liquid condensing pipes in the second region and air in the first air channel is greater than a contact area between two or more liquid condensing pipes in the third region and the air in the first air channel. The fan is disposed in the housing and located on a side of the condenser away from the evaporator. The air in the first air channel passes through the evaporator, outer surfaces of the plurality of liquid condensing pipes, and the condenser in sequence, and then enters the fan and is discharged from the dehumidifier by the fan. The air in the second air channel passes through an inner space of the plurality of liquid condensing pipes and the condenser in sequence, and then enters the fan and is discharged from the dehumidifier by the fan.

In another aspect, a dehumidifier is provided. The dehumidifier includes a housing, an evaporator, a condenser, a liquid condensing device, and a fan. A first air channel and a second air channel are disposed in the housing. The evaporator is disposed in the housing. The condenser is disposed in the housing. The evaporator and the condenser are arranged in sequence in a first direction and located in the first air channel. The liquid condensing device is disposed in the housing and located between the evaporator and the condenser. The liquid condensing device includes a body, a first support plate, a second support plate, a first air inlet cavity, and a second air inlet cavity. The first support plate and the second support plate are arranged at two ends of the body, respectively. A side of the first support plate away from the body is recessed, so as to constitute the first air inlet cavity. The first air inlet cavity is communicated with the second air channel and the body. A side of the second support plate away from the body is recessed, so as to constitute the second air inlet cavity. The second air inlet cavity is communicated with the second air channel and the body. The fan is disposed in the housing and located on a side of the condenser away from the evaporator. The air in the first air channel passes through the evaporator, an outer surface of the body, and the condenser in sequence, and then enters the fan and is discharged from the dehumidifier by the fan. The air in the second air channel passes through an inner space of the body and the condenser in sequence through the first air inlet cavity and the second air inlet cavity, and then enters the fan and is discharged from the dehumidifier by the fan.

### BRIEF DESCRIPTION OF THE DRAWINGS

FIG. 1 is a diagram showing a structure of a dehumidifier, in accordance with some embodiments;

FIG. 2 is a diagram showing another structure of a dehumidifier, in accordance with some embodiments;

FIG. 3 is an exploded view showing a partial structure of a dehumidifier, in accordance with some embodiments;

FIG. 4 is another exploded view showing a partial structure of a dehumidifier, in accordance with some embodiments;

FIG. 5 is a sectional view of a dehumidifier, in accordance with some embodiments;

FIG. 6 is a diagram showing a structure of a liquid condensing device, in accordance with some embodiments;

FIG. 7 is a diagram showing a structure of a first air channel in a dehumidifier, in accordance with some embodiments;

FIG. 8 is a diagram showing a structure of a second air channel in a dehumidifier, in accordance with some embodiments;

FIG. 9 is a diagram showing another structure of a liquid condensing device, in accordance with some embodiments;

FIG. 10 is a partial enlarged view of the circle B in FIG. 9;

FIG. 11 is a partial enlarged view of the circle C in FIG. 9;

FIG. 12 is a diagram showing yet another structure of a liquid condensing device, in accordance with some embodiments;

FIG. 13 is a diagram showing yet another structure of a liquid condensing device, in accordance with some embodiments;

FIG. 14 is a partial enlarged view of the circle A in FIG. 13;

FIG. 15 is a top view of a liquid condensing device, in accordance with some embodiments;

FIG. 16 is a diagram showing yet another structure of a liquid condensing device, in accordance with some embodiments;

FIG. 17 is a diagram showing yet another structure of a liquid condensing device, in accordance with some embodiments;

FIG. 18 is a diagram showing yet another structure of a liquid condensing device, in accordance with some embodiments;

FIG. 19 is a bottom view of a liquid condensing device, in accordance with some embodiments;

FIG. 20 is a diagram showing yet another structure of a liquid condensing device, in accordance with some embodiments;

FIG. 21 is a diagram showing yet another structure of a liquid condensing device from another perspective, in accordance with some embodiments;

FIG. 22 is a diagram showing yet another structure of a liquid condensing device, in accordance with some embodiments;

FIG. 23 is a diagram showing yet another structure of a liquid condensing device, in accordance with some embodiments;

FIG. 24 is a diagram showing yet another structure of a liquid condensing device, in accordance with some embodiments;

FIG. 25 is a diagram showing a structure of a housing, in accordance with some embodiments;

FIG. 26 is a diagram showing another structure of a second air channel in a dehumidifier, in accordance with some embodiments;

FIG. 27 is a diagram showing yet another structure of a liquid condensing device, in accordance with some embodiments; and

FIG. 28 is a diagram showing yet another structure of a liquid condensing device, in accordance with some embodiments.

### DETAILED DESCRIPTION

Some embodiments of the present disclosure will be clearly and completely described below with reference to the accompanying drawings. However, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to.” In the description, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only and are not to be construed as indicating or implying the relative importance or implicitly indicating the number of indicated technical features. Thus, features defined by “first” or “second” may explicitly or implicitly include one or more of the features. In the description of the embodiments of the present disclosure, the term “a plurality of” or “the plurality of” means two or more unless otherwise specified.

In the description of some embodiments, the term “connected” and derivatives thereof may be used. The term “connected” should be understood in a broad sense. For example, the term “connected” may represent a fixed connection, a detachable connection, or a one-piece connection, or may represent a direct connection, or may represent an indirect connection through an intermediate medium. The embodiments disclosed herein are not necessarily limited to the content herein.

The phrase “A and/or B” includes the following three combinations: only A, only B, and a combination of A and B.

The use of the phrase “applicable to” or “configured to” herein means an open and inclusive expression, which does not exclude devices that are applicable to or configured to perform additional tasks or steps.

Generally, a dehumidifier includes a housing, an evaporator, a condenser, and a liquid condensing device. The liquid condensing device is used to get indoor air into it. The low temperature air passing through the evaporator may perform heat exchange with the indoor air in the liquid condensing device, so that moisture in the indoor air condenses into condensed water, thereby achieving the dehumidification for the indoor air. However, the low temperature air passing through the evaporator has different coldness at different positions of the liquid condensing device due to a supercooling phenomenon existing in a part of the evaporator and different flow rates of the air passing through different portions of the evaporator. As a result, the liquid condensing device has a difficulty in making full use of coldness of the low temperature air, and the dehumidifier has low utilization on coldness of the low temperature air and has a low dehumidification efficiency.

In order to solve the above problems, a dehumidifier 1 is provided in some embodiments of the present disclosure.

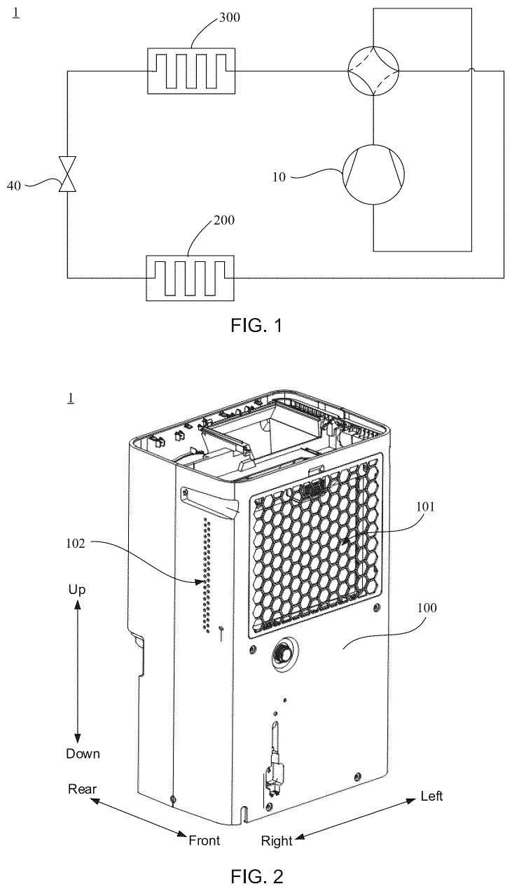

FIG. 1 is a diagram showing a structure of a dehumidifier, in accordance with some embodiments.

As shown in FIG. 1, the dehumidifier 1 includes a compressor 10, an evaporator 200, a condenser 300, and an expansion valve 40. The compressor 10, the condenser 300, the expansion valve 40, and the evaporator 200 are sequentially connected to form a refrigerant cycle. Refrigerant circulates in the refrigerant cycle and performs heat exchange with the air passing through the evaporator 200 and the condenser 300, thereby regulating the humidity and temperature of the surrounding environment.

The compressor 10 is configured to compress the refrigerant, so as to compress the refrigerant with low pressure to be the refrigerant with a high pressure. The refrigerant discharged from the compressor 10 flows into the condenser 300.

The condenser 300 is configured to perform heat exchange between the surrounding air and the refrigerant flowing in the condenser 300. The refrigerant compressed by the compressor 10 condenses by dissipating heat to the surrounding air through the condenser 300, and the condensed refrigerant is discharged from the condenser 300 to the expansion valve 40.

The expansion valve 40 is connected between the condenser 300 and the evaporator 200. A pressure of the refrigerant flowing through the condenser 300 and the evaporator 200 is regulated by controlling an opening degree of the expansion valve 40, so as to regulate a flow rate of the refrigerant flowing between the condenser 300 and the evaporator 200. The flow rate and pressure of the refrigerant flowing between the condenser 300 and the evaporator 200 may affect heat exchange capabilities of the condenser 300 and the evaporator 200. The expansion valve 40 has an adjustable opening degree, so as to control the flow rate and pressure of the refrigerant flowing through the expansion valve 40. For example, the expansion valve 40 makes the liquid refrigerant condensing in the condenser 300 expand into the liquid refrigerant with low pressure, and the liquid refrigerant with low pressure is discharged from the expansion valve 40 to the evaporator 200.

The evaporator 200 is configured to perform heat exchange between the surrounding air and the refrigerant flowing in the evaporator 200. The refrigerant dissipated by the condenser 300 evaporates by absorbing the heat of the surrounding air through the evaporator 200, and the refrigerant flows back to the compressor 10 after evaporation, thereby completing the circulating flow of the refrigerant.

In the process of the refrigerant cycle, indoor air may be drawn into the dehumidifier 1 and pass through the evaporator 200 and the condenser 300 in sequence. When the drawn indoor air passes through the evaporator 200, moisture in the indoor air condenses into condensed water on a surface of the evaporator 200. The dried indoor air performs heat exchange with the condenser 300, and the indoor air absorbs heat and is discharged from the dehumidifier 1, thereby achieving the dehumidification for the indoor air.

The dehumidifier 1 in some embodiments of the present disclosure is described in detail below.

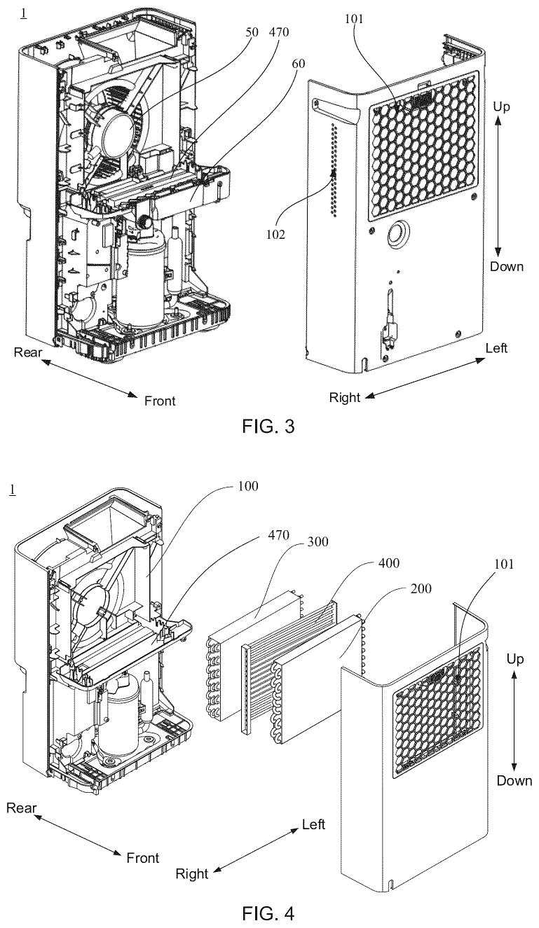

FIG. 2 is a diagram showing another structure of a dehumidifier, in accordance with some embodiments. FIG. 3 is an exploded view showing a partial structure of a dehumidifier, in accordance with some embodiments. FIG. 4 is another exploded view showing a partial structure of a dehumidifier, in accordance with some embodiments.

As shown in FIGS. 2 to 4, the dehumidifier 1 further includes a housing 100, a liquid condensing device 400, and a fan 50. The evaporator 200, the condenser 300, the liquid condensing device 400, and the fan 50 are disposed in the housing 100.

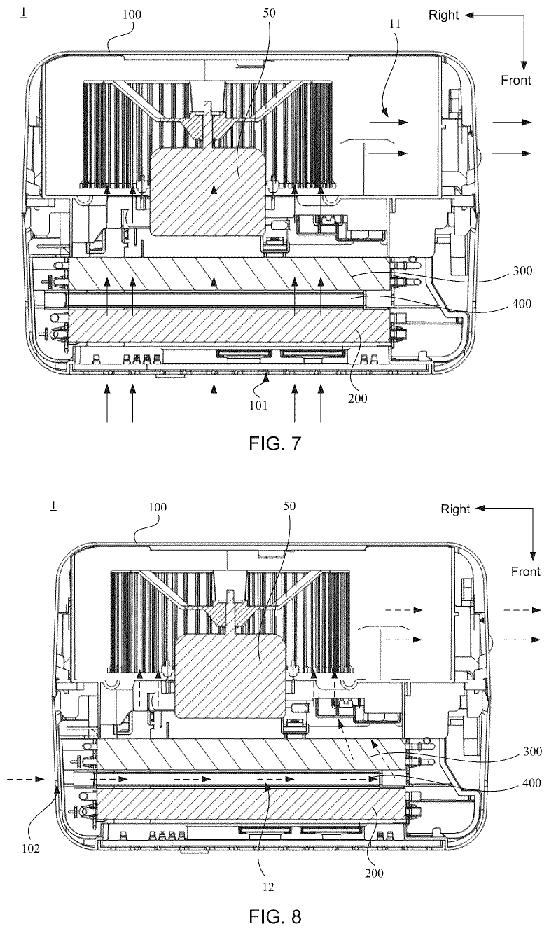

A first air channel 11 (as shown in FIG. 7) and a second air channel 12 (as shown in FIG. 8) are disposed in the housing 100, and the first air channel 11 and the second air channel 12 each may guide the indoor air entering the dehumidifier 1, so that the indoor air may flow through different components of the dehumidifier 1 according to the corresponding paths.

The evaporator 200 and the condenser 300 are arranged in a first direction and located in the first air channel 11. The first direction is parallel to a width direction (e.g., the front-rear direction in FIG. 2) of the dehumidifier 1. For example, the first direction is a direction from front to rear in FIG. 2.

The evaporator 200 and the condenser 300 each may include copper tubes and fins. The refrigerant may flow in the copper tubes, so as to perform heat exchange with the air flowing through the evaporator 200 or the condenser 300. The fins are connected with the copper tubes, so as to increase a heat exchange area of the evaporator 200 or the condenser 300 with the air flowing through the evaporator 200 or the condenser 300, thereby improving the heat exchange effect of the evaporator 200 or the condenser 300. The fins in the evaporator 200 may be made of hydrophilic materials (e.g., chromium, aluminum, or zinc), which is helpful for condensed water to flow down the surface of the evaporator 200. The term “hydrophilic” means that the object has a high affinity for water and may attract water molecules.

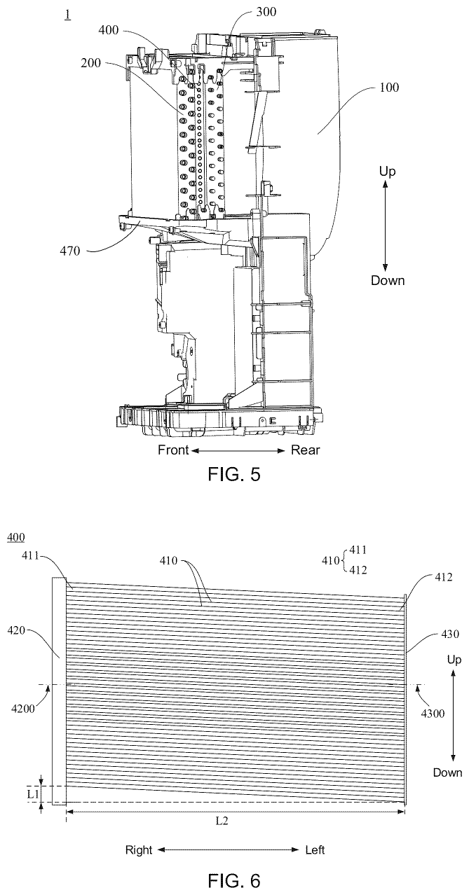

FIG. 5 is a sectional view of a dehumidifier, in accordance with some embodiments.

As shown in FIG. 5, the liquid condensing device 400 is located between the evaporator 200 and the condenser 300. The liquid condensing device 400 may be installed between the evaporator 200 and the condenser 300 by increasing a distance between the evaporator 200 and the condenser 300.

FIG. 6 is a diagram showing a structure of a liquid condensing device, in accordance with some embodiments. FIG. 7 is a diagram showing a structure of a first air channel in a dehumidifier, in accordance with some embodiments. FIG. 8 is a diagram showing a structure of a second air channel in a dehumidifier, in accordance with some embodiments. The solid arrows in FIG. 7 indicate a flow direction of the air in the first air channel 11, and the dotted arrows in FIG. 8 indicate a flow direction of the air in the second air channel 12.

As shown in FIG. 6, the liquid condensing device 400 includes a plurality of liquid condensing pipes 410. The plurality of liquid condensing pipes 410 extend in a second direction and are communicated with the second air channel 12. The second direction is parallel to a length direction (e.g., the left-right direction in FIG. 2) of the dehumidifier 1. For example, the second direction is a direction from right to left in FIGS. 2 and 6. The second direction is perpendicular to the first direction.

In this case, as shown in FIG. 7, the air in the first air channel 11 passes through an outer surface of the evaporator 200, outer surfaces of the plurality of liquid condensing pipes 410, and an outer surface of the condenser 300 in sequence, and then enters the fan 50 and is discharged from the dehumidifier 1 by the fan 50. As shown in FIG. 8, the air in the second air channel 12 passes through an inner space of the plurality of liquid condensing pipes 410 and the outer surface of the condenser 300, and then enters the fan 50 and is discharged from the dehumidifier 1 by the fan 50.

For example, as shown in FIG. 7, the fan 50 draws a first portion of the indoor air into the housing 100 through a main air inlet 101 of the dehumidifier 1. The first portion of the indoor air enters the first air channel 11 and performs heat exchange with the evaporator 200, so that moisture in the indoor air condenses into condensed water on the surface of the evaporator 200, thereby achieving the dehumidification for the air in the first air channel 11. After dehumidified by the evaporator 200, the air becomes the air with low temperature. As shown in FIG. 8, a second portion of the indoor air enters the housing 100 through a secondary air inlet 102 of the dehumidifier 1 and enters the plurality of liquid condensing pipes 410 through the second air channel 12. In this case, the low temperature air passing through the evaporator 200 flows through the outer surfaces of the plurality of liquid condensing pipes 410 and performs heat exchange with the second portion of the indoor air in the plurality of liquid condensing pipes 410, so that moisture in the second portion of the indoor air condenses into condensed water, thereby achieving the dehumidification for the air in the second air channel 12. Afterwards, the dehumidified air is heated by the condenser 300, which further reduces the humidity of the air, so that the air becomes dry air with moderate temperature and flows into the indoor environment, thereby completing the dehumidification for the indoor air.

The fan 50 is configured to drive the air in the first air channel 11 and the second air channel 12 to flow. The fan 50 drives the air to flow, which may increase a flow velocity of the air in the first air channel 11 and the second air channel 12. In this way, the air in the first air channel 11 may perform heat exchange with the evaporator 200 and the condenser 300. Moreover, the flow rate of the air entering the first air channel 11 and the second air channel 12 may be increased, thereby increasing the dehumidification amount of the dehumidifier 1 and improving the dehumidification efficiency of the dehumidifier 1.

In some embodiments of the present disclosure, the air in the first air channel 11 may be cooled, condensed, and dehumidified by the evaporator 200, and the air in the second air channel 12 may be cooled, condensed, and dehumidified in the plurality of liquid condensing pipes 410 by the low temperature air in the first air channel 11. In this way, the utilization of the low temperature air in the first air channel 11 may be improved, the dehumidification amount of the dehumidifier 1 may be increased, and the dehumidification efficiency of the dehumidifier 1 may be improved.

The liquid condensing device 400 in some embodiments of the present disclosure is described in detail below.

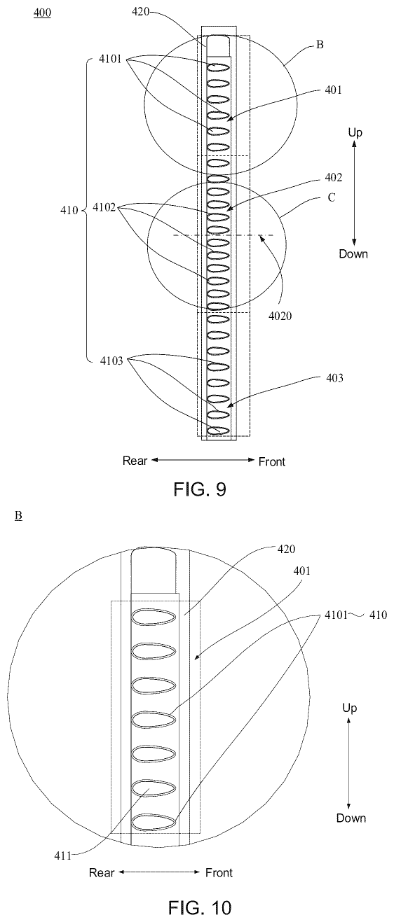

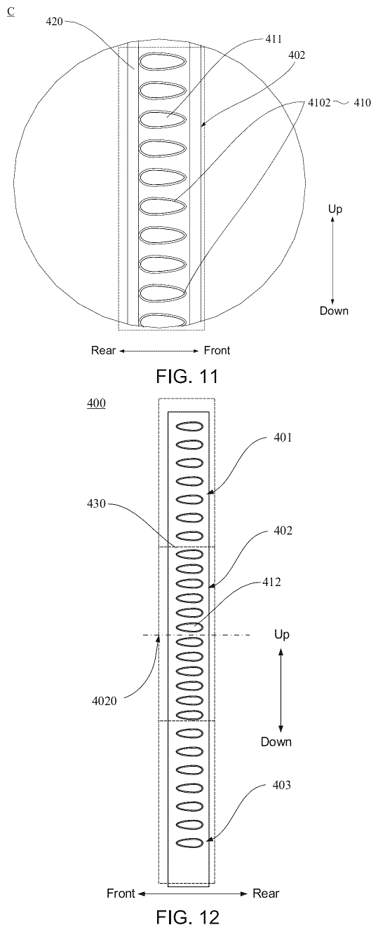

FIG. 9 is a diagram showing another structure of a liquid condensing device, in accordance with some embodiments. FIG. 10 is a partial enlarged view of the circle B in FIG. 9. FIG. 11 is a partial enlarged view of the circle C in FIG. 9.

In some embodiments, as shown in FIGS. 9 to 11, the plurality of liquid condensing pipes 410 are located in a first region 401, a second region 402, and a third region 403. The first region 401, the second region 402, and the third region 403 are arranged in a third direction. The third direction is parallel to a height direction (e.g., the up-down direction in FIG. 2) of the dehumidifier 1, and the third direction is perpendicular to the first direction and the second direction. For example, the third direction is a direction from up to down in FIG. 9. The first region 401, the second region 402, and the third region 403 each are provided with two or more liquid condensing pipes 410. For example, as shown in FIG. 9, the plurality of liquid condensing pipes 410 include a plurality of first liquid condensing sub-pipes 4101, a plurality of second liquid condensing sub-pipes 4102, and a plurality of third liquid condensing sub-pipes 4103. The plurality of first liquid condensing sub-pipes 4101 are located in the first region 401, the plurality of second liquid condensing sub-pipes 4102 are located in the second region 402, and the plurality of third liquid condensing sub-pipes 4103 are located in the third region 403.

It will be noted that the plurality of dotted boxes in FIG. 9 correspond to the first region 401, the second region 402, and the third region 403, respectively.

In some embodiments, as shown in FIGS. 9 to 11, a distance between two adjacent second liquid condensing sub-pipes 4102 is less than a distance between two adjacent first liquid condensing sub-pipes 4101, and the distance between two adjacent second liquid condensing sub-pipes 4102 is less than a distance between two adjacent third liquid condensing sub-pipes 4103. In this way, a distribution density of the liquid condensing pipes in the second region 402 is greater than a distribution density of the liquid condensing pipes in the first region 401, and the distribution density of the liquid condensing pipes in the second region 402 is greater than a distribution density of the liquid condensing pipes in the third region 403. Here, the distribution density of the liquid condensing pipes refers to the number of liquid condensing pipes 410 per unit area.

A supercooling phenomenon may easily occur in the middle of the evaporator 200 in the third direction within a temperature range (e.g., a range of 12° C. to 28° C.). Moreover, the flow rate of the air in the middle of the evaporator 200 is high due to the design of the air channel of the dehumidifier 1. In this way, compared with other portions of the evaporator 200, the low temperature air passing through the middle of the evaporator 200 has more coldness. However, in some embodiments of the present disclosure, since the density of the plurality of second liquid condensing sub-pipes 4102 is greater than the density of the plurality of first liquid condensing sub-pipes 4101, and the density of the plurality of second liquid condensing sub-pipes 4102 is greater than the density of the plurality of third liquid condensing sub-pipes 4103, a flow resistance of the low temperature air passing through the evaporator 200 at the plurality of second liquid condensing sub-pipes 4102 is greater than that at the plurality of first liquid condensing sub-pipes 4101 or the plurality of third liquid condensing sub-pipes 4103.

In this way, the low temperature air has a long time to be in contact with the plurality of second liquid condensing sub-pipes 4102. Moreover, the plurality of second liquid condensing sub-pipes 4102 has a large contacting area with the low temperature air due to the dense arrangement of the plurality of second liquid condensing sub-pipes 4102, so that the low temperature air may perform sufficient heat exchange with the plurality of second liquid condensing sub-pipes 4102, which improves the utilization of the dehumidifier 1 on coldness of the low temperature air flowing out of the evaporator 200, thereby improving the dehumidification efficiency of the dehumidifier 1. Here, the supercooling phenomenon refers to a phenomenon that the liquid cannot solidify at the preset pressure in a case where the temperature of the liquid is less than a freezing point of the liquid at the pressure. The coldness may refer to a total energy value of the heat of target space consumed or a total energy value of the heat absorbed from target space by the device (e.g., the dehumidifier 1) by means of cooling in unit time.

It will be noted that the large contact area of the plurality of second liquid condensing sub-pipes 4102 with the low temperature air may be understood as surface areas of the plurality of second liquid condensing sub-pipes 4102 are greater than surface areas of the plurality of first liquid condensing sub-pipes 4101, and the surface areas of the plurality of second liquid condensing sub-pipes 4102 are greater than surface areas of the plurality of third liquid condensing sub-pipes 4103. Here, the surface areas of the plurality of liquid condensing pipes 410 may refer to a surface area of any one of the plurality of liquid condensing pipes 410 or a total surface area of the plurality of liquid condensing pipes 410.

In some embodiments, the liquid condensing device 400 satisfies at least one of the following: the distance between two adjacent first liquid condensing sub-pipes 4101 of the plurality of first liquid condensing sub-pipes 4101 may be the same as the distance between two adjacent third liquid condensing sub-pipes 4103 of the plurality of third liquid condensing sub-pipes 4103; alternatively, the number of the plurality of first liquid condensing sub-pipes 4101 may be the same as the number of the plurality of third liquid condensing sub-pipes 4103.

In a case where the distance between two adjacent first liquid condensing sub-pipes 4101 is the same as the distance between two adjacent third liquid condensing sub-pipes 4103, and the number of the plurality of first liquid condensing sub-pipes 4101 is the same as the number of the plurality of third liquid condensing sub-pipes 4103, the plurality of first liquid condensing sub-pipes 4101 and the plurality of third liquid condensing sub-pipes 4103 may be arranged symmetrically in the third direction, so as to simplify the structure of the liquid condensing device 400, thereby facilitating the processing and production of the liquid condensing device 400. In this case, the heat exchange efficiency of the plurality of first liquid condensing sub-pipes 4101 with the low temperature air in the first air channel 11 is substantially the same as the heat exchange efficiency of the plurality of third liquid condensing sub-pipes 4103 with the low temperature air in the first air channel 11, and an air supply velocity of the first region 401 is the same as that of the third region 403, which improves the uniformity of air supply. The air supply velocity may refer to a flow velocity of the air.

In some embodiments, the distance between each two adjacent second liquid condensing sub-pipes 4102 of the plurality of second liquid condensing sub-pipes 4102 may be same, so as to simplify the structure of the plurality of second liquid condensing sub-pipes 4102, which is conducive to processing the plurality of second liquid condensing sub-pipes 4102.

Of course, in some embodiments, the distance between each two adjacent second liquid condensing sub-pipes 4102 of the plurality of second liquid condensing sub-pipes 4102 may also be different. For example, as shown in FIG. 9, the second region 402 has a first center plane 4020, and the first center plane 4020 is located in a center of the second region 402 and perpendicular to the third direction. In this case, the distance between two adjacent second liquid condensing sub-pipes 4102 decreases in a direction (e.g., from up to down, or from down to up) parallel to the third direction and proximate to the first center plane 4020. As a result, the distance between two adjacent second liquid condensing sub-pipes 4102 away from the first center plane 4020 is greater than that between two adjacent second liquid condensing sub-pipes 4102 proximate to the first center plane 4020. The closer to the first center plane 4020, the less the coldness of the low temperature air. Therefore, the second liquid condensing sub-pipes 4102 proximate to the first center plane 4020 may perform sufficient heat exchange with the low temperature air in the first air channel 11 by adjusting the distance between the two adjacent second liquid condensing sub-pipes 4102, thereby improving the dehumidification efficiency of the dehumidifier 1.

FIG. 12 is a diagram showing yet another structure of a liquid condensing device, in accordance with some embodiments.

In some embodiments, as shown in FIGS. 9 and 12, the plurality of second liquid condensing sub-pipes 4102 are symmetrically arranged with respect to the first center plane 4020, so as to simplify the structure of the plurality of second liquid condensing sub-pipes 4102, thereby simplifying the overall structure of the liquid condensing device 400 and facilitating the processing of the liquid condensing device 400.

In some embodiments, as shown in FIG. 6, the liquid condensing pipe 410 includes an air inlet end 411 and an air outlet end 412. The air in the second air channel 12 flows into the liquid condensing pipe 410 from the air inlet end 411 and flows out of the liquid condensing pipe 410 from the air outlet end 412. Moreover, the air flowing out of the air outlet end 412 is mixed with the air passing through the evaporator 200 and the liquid condensing device 400 in the first air channel 11, and the mixing of the air takes place on a side (e.g., a front side) of the condenser 300 proximate to the evaporator 200. Here, the front side of the condenser 300 refers to a front side of the condenser 300 in a flow direction of the air in the first air channel 11, so that the air in the first air channel 11 may first flow through the front side of the condenser 300 after passing through the evaporator 200 and the liquid condensing device 400.

The indoor air entering the second air channel 12 may enter the liquid condensing pipe 410 through the air inlet end 411. After performing heat exchange with the low temperature air in the first air channel 11, the air in the liquid condensing pipe 410 is discharged from the air outlet end 412 and mixed with the air in the first air channel 11. The mixed air flows to the condenser 300 and becomes dry air with moderate temperature and flow back to the indoor environment after performing heat exchange with the condenser 300.

For example, the air inlet end 411 is a first end of the liquid condensing pipe 410 in an axial direction of the liquid condensing pipe 410, and the air outlet end 412 is a second end of the liquid condensing pipe 410 in an axial direction of the liquid condensing pipe 410. In this way, there is a long distance between the air inlet end 411 and the air outlet end 412 of the liquid condensing pipe 410, and the air in the liquid condensing pipe 410 flows over a long path and for a long time, so that the air in the liquid condensing pipe 410 may perform sufficient heat exchange with the low temperature air in the first air channel 11. As a result, moisture in the air in the liquid condensing pipe 410 may condense into condensed water, thereby improving the dehumidification efficiency of the dehumidifier 1.

In some embodiments, as shown in FIG. 6, the liquid condensing pipe 410 is inclined downward in the second direction (e.g., in a direction from the air inlet end 411 to the air outlet end 412), so that the air inlet end 411 is higher than the air outlet end 412. In this way, condensed water in the liquid condensing pipe 410 may flow quickly due to the action of gravity. As a result, the accumulation of condensed water in the liquid condensing pipe 410 may be avoided, so that condensed water may be quickly discharged from the liquid condensing device 400.

A slope of the liquid condensing pipe 410 may be greater than a preset value (e.g., 3%). In this way, the liquid condensing pipe 410 has a large slope. That is to say, the liquid condensing pipe 410 has a large inclined angle with respect to a horizontal plane. In this case, condensed water in the liquid condensing pipe 410 may flow quickly due to the action of gravity, which prevents condensed water from accumulating in the liquid condensing pipe 410, so that condensed water may be quickly discharged from the liquid condensing device 400. Here, the slope may be a ratio of a size L1 (as shown in FIG. 6) of an orthogonal projection of the liquid condensing pipe 410 on a plane perpendicular to the second direction in the third direction to a size L2 (as shown in FIG. 6) of an orthogonal projection of the liquid condensing pipe 410 on a plane perpendicular to the third direction in the second direction.

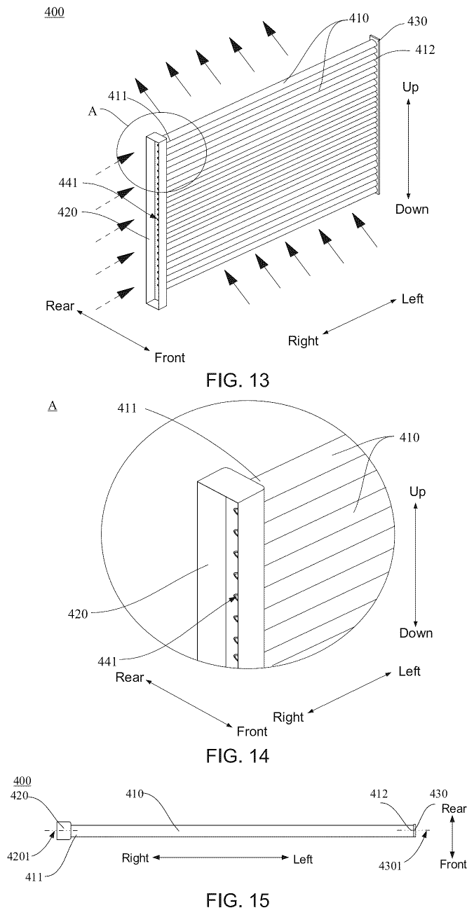

FIG. 13 is a diagram showing yet another structure of a liquid condensing device, in accordance with some embodiments. FIG. 14 is a partial enlarged view of the circle A in FIG. 13. FIG. 15 is a top view of a liquid condensing device, in accordance with some embodiments. The solid arrows in FIG. 13 indicate substantially a flow direction of the air in the first air channel 11, and the dashed arrows in FIG. 13 indicate substantially a flow direction of the air in the second air channel 12.

In some embodiments, as shown in FIGS. 6 and 13, the liquid condensing device 400 further includes a first support plate 420 and a second support plate 430. The first support plate 420 and the second support plate 430 are disposed at two ends of the liquid condensing pipe 410 in the second direction, respectively. The first support plate 420 and the second support plate 430 may support and fix the liquid condensing pipes 410, which is conducive to increasing the structural strength of the liquid condensing device 400. The first support plate 420 and the second support plate 430 may be connected (e.g., connected by snaps or by screws) to the condenser 300, so as to achieve a fixed connection between the liquid condensing device 400 and the condenser 300.

As shown in FIGS. 13 and 14, the first support plate 420 is provided with a first air inlet cavity 441. The first air inlet cavity 441 is communicated with the plurality of liquid condensing pipes 410. The first end (e.g., the air inlet end 411) of the liquid condensing pipe 410 proximate to the first support plate 420 is connected to a bottom wall of the first air inlet cavity 441, and the air inlet end 411 of the liquid condensing pipe 410 is communicated with the first air inlet cavity 441.

The first air inlet cavity 441 is communicated with the indoor environment through the secondary air inlet 102 of the dehumidifier 1, so that a part of the indoor air may flow into the first air inlet cavity 441. Then, the indoor air may enter the air inlet ends 411 of the liquid condensing pipes 410 through the first air inlet cavity 441, so as to prevent the first support plate 420 from blocking the air inlet ends 411 of the liquid condensing pipes 410. The air may flow smoothly into the liquid condensing pipes 410, and the uniformity of the air entering the liquid condensing pipes 410 is improved.

In addition, as shown in FIG. 15, the second end (e.g., the air outlet end 412) of the liquid condensing pipe 410 proximate to the second support plate 430 is connected to and runs through the second support plate 430, so as to prevent the second support plate 430 from blocking the discharge of the air and condensed water in the liquid condensing pipes 410.

In some embodiments, as shown in FIG. 6, a length of the first support plate 420 is greater than a length of the second support plate 430 in the third direction, and a second center plane 4200 corresponding to a length direction of the first support plate 420 coincides with a third center plane 4300 corresponding to a length direction of the second support plate 430. Alternatively, as shown in FIG. 15, a width of the first support plate 420 is greater than a width of the second support plate 430 in the first direction, and a fourth center plane 4201 corresponding to a width direction of the first support plate 420 coincides with a fifth center plane 4301 corresponding to a width direction of the second support plate 430. Alternatively, as shown in FIGS. 6 and 15, the length of the first support plate 420 is greater than the length of the second support plate 430 in the third direction, and the second center plane 4200 corresponding to the length direction of the first support plate 420 coincides with the third center plane 4300 corresponding to the length direction of the second support plate 430. Moreover, the width of the first support plate 420 is greater than the width of the second support plate 430 in the first direction, and the fourth center plane 4201 corresponding to the width direction of the first support plate 420 coincides with the fifth center plane 4301 corresponding to the width direction of the second support plate 430.

It will be noted that the second center plane 4200 passes through the center of the first support plate 420 and is perpendicular to the third direction. The third center plane 4300 passes through a center of the second support plate 430 and is perpendicular to the third direction. The fourth center plane 4201 passes through the center of the first support plate 420 and is perpendicular to the first direction. The fifth center plane 4301 passes through the center of the second support plate 430 and is perpendicular to the first direction.

In this case, the first support plate 420 and the second support plate 430 may be arranged regularly, the structure of the liquid condensing device 400 is regular, and an overall thickness of the liquid condensing device 400 is thin, which is conducive to reducing space occupied by the liquid condensing device 400 and arranging the liquid condensing device 400. Moreover, a volume of the second support plate 430 is less than that of the first support plate 420, which may further reduce a volume of the liquid condensing device 400 and facilitate the installation and disassembly of the liquid condensing device 400. In addition, the liquid condensing device 400 is approximately in a shape of a pyramid, which is easy to pull out the liquid condensing device 400 from the dehumidifier 1 and insert the liquid condensing device 400 into the dehumidifier 1.

In some embodiments, a thickness of the second support plate 430 may be greater than 2 mm, and a thickness of the first support plate 420 may be greater than the thickness of the second support plate 430, so as to be conducive to machining the first air inlet cavity 441. For example, the thickness of the first support plate 420 and the thickness of the second support plate 430 are 2 mm, 2.5 mm, or 3 mm. In this way, the thickness of the first support plate 420 and the thickness of the second support plate 430 are thick, which is conducive to improving the structural strength and the fixed reliability of the liquid condensing device 400.

In some embodiments, corners of an inner wall of the first air inlet cavity 441 may be rounded corners. For example, a cross section of the first air inlet cavity 441 is in a shape of a rectangle, and corners of the rectangle are in a shape of an arc. In this way, the corners of the inner wall of the first air inlet cavity 441 are smooth, which may avoid vortexes at the corners of the inner wall of the first air inlet cavity 441, so as to be conducive to reducing the wind resistance in the first air inlet cavity 441. As a result, a flow field may be distributed uniformly in the first air inlet cavity 441, and the air flows smoothly, thereby improving the air volume and the uniformity of the air entering the liquid condensing device 400.

In some embodiments, the second ends (i.e., the air outlet end 412) of the liquid condensing pipes 410 are located on the same plane as a side (e.g., a left side) of the second support plate 430 away from the first support plate 420. For example, the air outlet ends 412 of the liquid condensing pipes 410 are aligned with the left side of the second support plate 430. In this way, condensed water in the liquid condensing pipes 410 may gently flow out from the side of the second support plate 430 away from the first support plate 420 along a direction from the first support plate 420 to the second support plate 430, so as to prevent condensed water from directly dripping and colliding with the air flowing in the dehumidifier 1, thereby avoiding splashing of condensed water.

In some embodiments, cross sections of the liquid condensing pipes 410 may be in a shape of at least one of a circle, an ellipse, or a water drop on a plane where the first direction and the third direction are located. For example, in the plurality of liquid condensing pipes 410, the cross sections of a first portion of the liquid condensing pipes 410 are in a shape of a circle, the cross sections of a second portion of the liquid condensing pipes 410 are in a shape of an ellipse, and the cross sections of a third portion of the liquid condensing pipes 410 are in a shape of a water drop.

Moreover, the cross sections of the liquid condensing pipes 410 are in a shape of a circle, an ellipse, or a water drop, which may reduce the flow resistance of the air in the first air channel 11 on the outer surfaces of the liquid condensing pipes 410. As a result, the air in the first air channel 11 flows smoothly, which is conducive to reducing the energy consumption of the fan 50, reducing the operating cost of the dehumidifier 1, and improving the dehumidification efficiency of the dehumidifier 1.

In some embodiments, on the plane where the first direction and the third direction are located, the cross sections of the plurality of second liquid condensing sub-pipes 4102 may be in a shape of a water drop, and the cross sections of the plurality of first liquid condensing sub-pipes 4101 and the plurality of third liquid condensing sub-pipes 4103 may be in a shape of a circle. In this way, since there is a large air volume in the middle of the evaporator 200, the wind resistance of the air flowing in the first air channel 11 may be reduced by providing the cross sections of the plurality of second liquid condensing sub-pipes 4102 in a shape of a water drop, thereby reducing the energy consumption of the fan 50.

In some embodiments, the plurality of liquid condensing pipes 410 may be arranged in a row along the third direction. Alternatively, the plurality of liquid condensing pipes 410 may be arranged in a plurality of rows in the first direction. Moreover, the positions of the liquid condensing pipes 410 in the plurality of rows of liquid condensing pipes 410 may be aligned with each other in the first direction. Alternatively, at least two rows of the plurality of rows of liquid condensing pipes 410 are separated from each other.

In some embodiments, the liquid condensing pipes 410 may be a metal pipe (e.g., copper tube). There is a hydrophobic layer on an inner wall of the liquid condensing pipe 410. The hydrophobic layer may be a coating of a compound (e.g., fluorosilane polymer) with hydrophobicity, so as to form a hydrophobic surface on the inner wall of the liquid condensing pipe 410, thereby improving the condensation heat transfer coefficient of the inner wall of the liquid condensing pipe 410. As a result, the low temperature air in the first air channel 11 may perform heat exchange with the air in the liquid condensing pipes 410, so as to improve the heat exchange effect. In this way, the liquid condensing pipes 410 may have a good condensation effect, thereby reducing moisture of the air in the liquid condensing pipes 410. It will be noted that when the water vapor is in contact with a solid wall below the saturation temperature of the water vapor, the water vapor releases heat of vaporization and condenses into liquid water, and the process may be referred to as the condensation heat transfer. In some embodiments, the liquid condensing pipes 410 may also be made of vinylidene fluoride.

The above is mainly described by considering an example in which the distance between two adjacent second liquid condensing sub-pipes 4102 in the liquid condensing device 400 is less than the distance between two adjacent first liquid condensing sub-pipes 4101, and the distance between two adjacent second liquid condensing sub-pipes 4102 is less than the distance between two adjacent third liquid condensing sub-pipes 4103. Of course, in some embodiments, the liquid condensing pipes 410 in the liquid condensing device 400 may also include other arrangement manners.

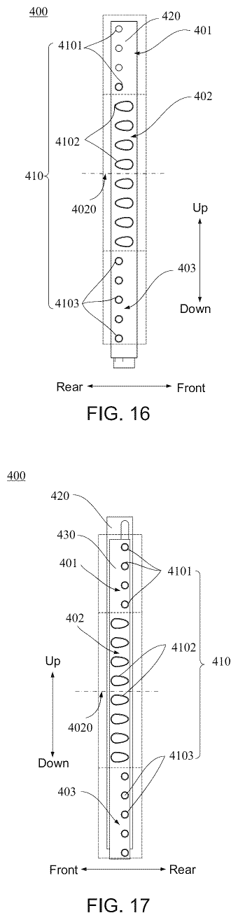

FIG. 16 is a diagram showing yet another structure of a liquid condensing device, in accordance with some embodiments. FIG. 17 is a diagram showing yet another structure of a liquid condensing device, in accordance with some embodiments.

As shown in FIGS. 16 and 17, on the plane where the first direction and the third direction are located, a cross-sectional area of any one of the plurality of second liquid condensing sub-pipes 4102 is greater than a cross-sectional area of any one of the plurality of first liquid condensing sub-pipes 4101, and the cross-sectional area of any one of the plurality of second liquid condensing sub-pipes 4102 is greater than a cross-sectional area of any one of the plurality of third liquid condensing sub-pipes 4103. In this case, the contact area between any one of the plurality of second liquid condensing sub-pipes 4102 and the air in the first air channel 11 is greater than the contact area between any one of the plurality of first liquid condensing sub-pipes 4101 and the air in the first air channel 11 and the contact area between any one of the plurality of third liquid condensing sub-pipes 4103 and the air in the first air channel 11.

In some embodiments, as shown in FIGS. 16 and 17, in the first direction, sides (e.g. rear sides) of the plurality of first liquid condensing sub-pipes 4101 proximate to the condenser 300, sides (e.g., rear sides) of the plurality of second liquid condensing sub-pipes 4102 proximate to the condenser 300, and sides (e.g., rear sides) of the plurality of third liquid condensing sub-pipes 4103 proximate to the condenser 300 are located on a same plane. For example, in the first direction, the rear sides of the plurality of first liquid condensing sub-pipes 4101, the rear sides of the plurality of second liquid condensing sub-pipes 4102, and the rear sides of the plurality of third liquid condensing sub-pipes 4103 are aligned with each other, so as to simplify the structure of the liquid condensing device 400 and make the structure of the plurality of liquid condensing pipes 410 proximate to the condenser 300 regular, which is conducive to positioning the liquid condensing device 400 when the liquid condensing device 400 is being produced.

Moreover, the low temperature air passing through the evaporator 200 may flow smoothly to the first region 401, the second region 402, and the third region 403, which prevent the air from flowing back, thereby reducing the wind resistance of the air in the first air channel 11 and improving the uniformity of airflow.

In some embodiments, as shown in FIGS. 16 and 17, in the first direction, sides (e.g., front sides) of the plurality of second liquid condensing sub-pipes 4102 proximate to the evaporator 200 are closer to the evaporator 200 than sides (e.g., front sides) of the plurality of first liquid condensing sub-pipes 4101 proximate to the evaporator 200 and sides (e.g., front sides) of the plurality of third liquid condensing sub-pipes 4103 proximate to the evaporator 200. For example, in the first direction, lengths of the plurality of second liquid condensing sub-pipes 4102 are greater than lengths of the plurality of first liquid condensing sub-pipes 4101, and the lengths of the plurality of second liquid condensing sub-pipes 4102 are greater than lengths of the plurality of third liquid condensing sub-pipes 4103. In this way, the contact area between the plurality of second liquid condensing sub-pipes 4102 and the low temperature air in the first air channel 11 is large, and the heat exchange time between the plurality of second liquid condensing sub-pipes 4102 and the low temperature air in the first air channel 11 is long, so that the heat exchange effect of the liquid condensing device 400 is improved, thereby improving the dehumidification effect of the dehumidifier 1. Moreover, an interval between any two adjacent second liquid condensing sub-pipes 4102 of the plurality of second liquid condensing sub-pipes 4102 in the third direction is substantially constant, so that the flow resistance of the air in the first air channel 11 may be reduced when the air passes through the second liquid condensing sub-pipes 4102.

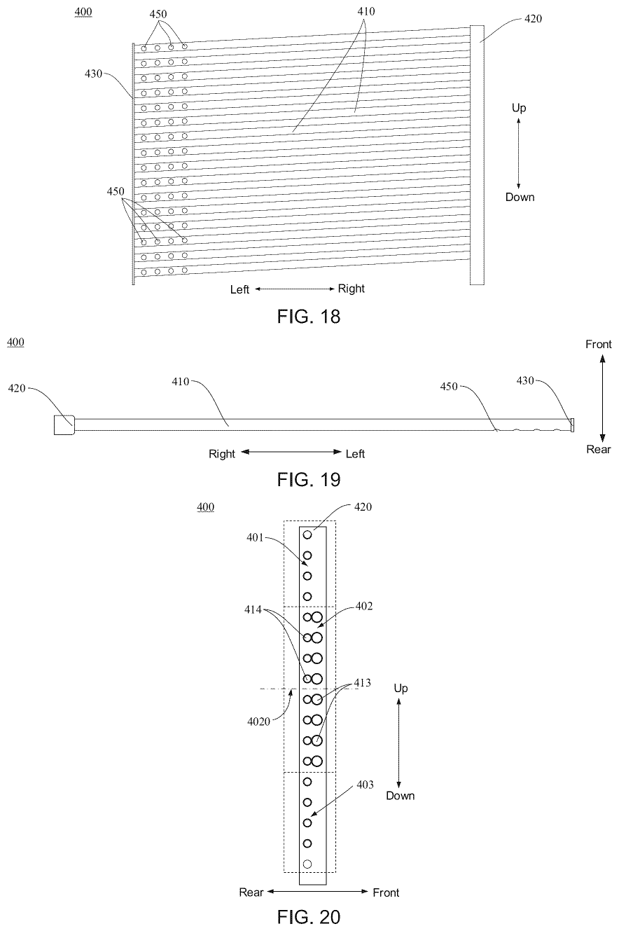

FIG. 18 is a diagram showing yet another structure of a liquid condensing device, in accordance with some embodiments. FIG. 19 is a bottom view of a liquid condensing device, in accordance with some embodiments.

In some embodiments, as shown in FIGS. 18 and 19, the liquid condensing device 400 further includes a plurality of second exhaust holes 450. The plurality of second exhaust holes 450 are disposed on sides (e.g., rear sides) of the plurality of liquid condensing pipes 410 facing the condenser 300, and one liquid condensing pipe 410 may be provided with one or more second exhaust holes 450. On one liquid condensing pipe 410, any two adjacent second exhaust holes 450 of the plurality of second exhaust holes 450 are arranged at an interval in a length direction of the liquid condensing pipe 410, so as to increase the heat exchange area of the air flowing out of the liquid condensing pipe 410 with the condenser 300. Moreover, the flow rate of the air drawn into the liquid condensing pipes 410 by the fan 50 and the air volume of the air passing through the condenser 300 may also be increased by providing the plurality of second exhaust holes 450, thereby improving the heat exchange effect of the condenser 300.

In some embodiments, on one liquid condensing pipe 410, the number of second exhaust holes 450 is less than or equal to a first preset value (e.g., five), and a distance between each second exhaust hole 450 and the air inlet end 411 is greater than a distance between the second exhaust hole 450 and the air outlet end 412. Moreover, a distance between any two of the plurality of second exhaust holes 450 is less than one third of a length of the liquid condensing pipe 410, and a diameter of the second exhaust hole 450 is less than an inner diameter of the liquid condensing pipe 410. In this way, the air in the liquid condensing pipes 410 may have sufficient heat exchange time with the air in the first air channel 11, so that moisture in the air in the liquid condensing pipes 410 may be fully condensed, thereby improving the dehumidification effect of the dehumidifier 1.

The above is mainly described by considering an example in which the cross-sectional area of any one of the plurality of second liquid condensing sub-pipes 4102 is greater than the cross-sectional area of any one of the plurality of first liquid condensing sub-pipes 4101, and the cross-sectional area of any one of the plurality of second liquid condensing sub-pipes 4102 is greater than the cross-sectional area of any one of the plurality of third liquid condensing sub-pipes 4103.

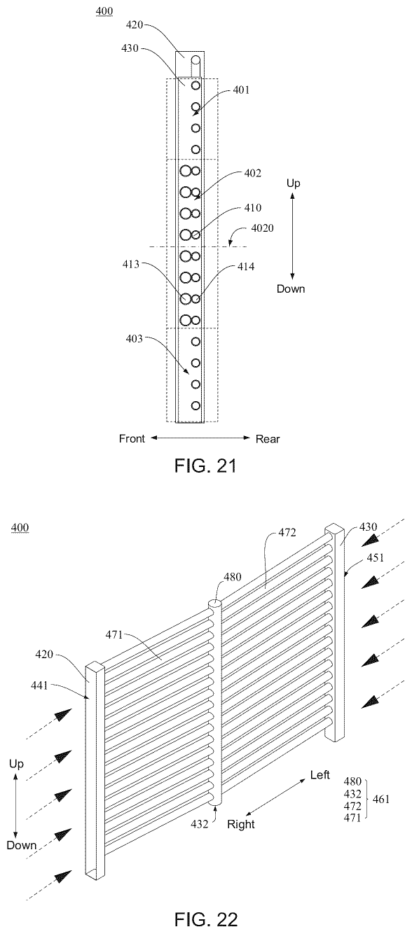

FIG. 20 is a diagram showing yet another structure of a liquid condensing device, in accordance with some embodiments. FIG. 21 is a diagram showing yet another structure of a liquid condensing device from another perspective, in accordance with some embodiments.

As shown in FIGS. 20 and 21, in the first direction, the number of rows of the plurality of second liquid condensing sub-pipes 4102 is greater than the number of rows of the plurality of first liquid condensing sub-pipes 4101 and the number of rows of the plurality of third liquid condensing sub-pipes 4103. In this way, by providing the plurality of rows of liquid condensing pipes 410 in the second region 402, the cross-sectional areas of the plurality of second liquid condensing sub-pipes 4102 may be indirectly increased, so that the contact area between the plurality of second liquid condensing sub-pipes 4102 and the air in the first air channel 11 is greater than the contact area between the plurality of first liquid condensing sub-pipes 4101 and the air in the first air channel 11, and the contact area between the plurality of second liquid condensing sub-pipes 4102 and the air in the first air channel 11 is greater than the contact area between the plurality of third liquid condensing sub-pipes 4103 and the air in the first air channel 11.

Moreover, the coldness of the low temperature air passing through the middle portion of the evaporator 200 is greater than the coldness of the low temperature air passing through other portions of the evaporator 200. That is to say, the coldness of the low temperature air in the first region 401 and the coldness of the low temperature air in the third region 403 are less than the coldness of the low temperature air in the second region 402. Therefore, the plurality of second liquid condensing sub-pipes 4102, the plurality of first liquid condensing sub-pipes 4101, and the plurality of third liquid condensing sub-pipes 4103 may be matched with the coldness of the low temperature air at their positions by providing the plurality of rows of second liquid condensing sub-pipes 4102, thereby improving the utilization of the coldness and dehumidification efficiency of the dehumidifier 1, and reducing energy consumption and saving costs.

In some embodiments, in the first direction, in a case where the number of rows of the plurality of first liquid condensing sub-pipes 4101 is the same as the number of rows of the plurality of third liquid condensing sub-pipes 4103, the liquid condensing device 400 satisfies at least one of the following: a distance between two adjacent first liquid condensing sub-pipes 4101 may be the same as a distance between two adjacent third liquid condensing sub-pipes 4103, or, the number of the plurality of first liquid condensing sub-pipes 4101 may be the same as the number of the plurality of third liquid condensing sub-pipes 4103. In this way, the plurality of first liquid condensing sub-pipes 4101 and the plurality of third liquid condensing sub-pipes 4103 may be symmetrically arranged in the third direction, so as to simplify the structure of the liquid condensing device 400, which is conducive to processing the liquid condensing device 400. Moreover, the heat exchange efficiency of the plurality of first liquid condensing sub-pipes 4101 with the low temperature air in the first air channel 11 may be substantially the same as the heat exchange efficiency of the plurality of third liquid condensing sub-pipes 4103 with the low temperature air in the first air channel 11, and the air supply velocity of the first region 401 is the same as the air supply velocity of the third region 403, thereby improving the uniformity of air supply.

Of course, in a case where the number of rows of the plurality of first liquid condensing sub-pipes 4101 is different from the number of rows of the plurality of third liquid condensing sub-pipes 4103, the distance between the two adjacent first liquid condensing sub-pipes 4101, the distance between the two adjacent third liquid condensing sub-pipes 4103, the number of the plurality of first liquid condensing sub-pipes 4101, and the number of the plurality of third liquid condensing sub-pipes 4103 may satisfy the above conditions. In some embodiments, as shown in FIGS. 20 and 21, the plurality of second liquid condensing sub-pipes 4102 are arranged into two rows in the first direction. In the two rows of second liquid condensing sub-pipes 4102, a row of second liquid condensing sub-pipes 4102 proximate to the evaporator 200 is the first row of liquid condensing pipes 413, and another row of second liquid condensing sub-pipes 4102 away from the evaporator 200 is the second row of liquid condensing pipes 414.

The first row of liquid condensing pipes 413 and the second row of liquid condensing pipes 414 are sequentially arranged in the first direction. The number of the liquid condensing pipes 410 in the first row of liquid condensing pipes 413 is the same as the number of the liquid condensing pipes 410 in the second row of liquid condensing pipes 414, and the liquid condensing pipes 410 in the first row of liquid condensing pipes 413 correspond to the liquid condensing pipes 410 in the second row of liquid condensing pipes 414, respectively. For example, the liquid condensing pipes 410 in the first row of liquid condensing pipes 413 and the corresponding liquid condensing pipes 410 in the second row of liquid condensing pipes 414 are at a same height. On the plane where the first direction and the third direction are located, a cross-sectional area of any liquid condensing pipe 410 in the first row of liquid condensing pipes 413 is greater than a cross-sectional area of any liquid condensing pipe 410 in the second row of liquid condensing pipes 414.

The number of liquid condensing pipes 410 in the first row of liquid condensing pipes 413 is the same as the number of liquid condensing pipes 410 in the second row of liquid condensing pipes 414 and their positions correspond to each other, so that a distance between the two adjacent liquid condensing pipes 410 in the first row of liquid condensing pipes 413 may be the same as a distance between the two adjacent liquid condensing pipes 410 in the second row of liquid condensing pipes 414. The distance between the two adjacent liquid condensing pipes 410 in the first row of liquid condensing pipes 413 may refer to a distance between central axes of the two adjacent liquid condensing pipes 410 in the first row of liquid condensing pipes 413. The distance between the two adjacent liquid condensing pipes 410 in the second row of liquid condensing pipes 414 may refer to a distance between central axes of the two adjacent liquid condensing pipes 410 in the second row of liquid condensing pipes 414.

In this case, after passing through gaps in the first row of liquid condensing pipes 413, the air in the first air channel 11 may directly enter gaps in the second row of liquid condensing pipes 414 and flow to the condenser 300. In this way, the flow resistance of the air in the first air channel 11 at the liquid condensing device 400 may be reduced, and the airflow may flow smoothly.

In some embodiments, on the plane where the first direction and the third direction are located, the cross-sectional areas of the plurality of liquid condensing pipes 410 in the first row of liquid condensing pipes 413 are same, the cross-sectional areas of the plurality of liquid condensing pipes 410 in the second row of liquid condensing pipes 414 are same, and the cross-sectional areas of the liquid condensing pipes 410 in the first row of liquid condensing pipes 413 are greater than the cross-sectional areas of the liquid condensing pipes 410 in the second row of liquid condensing pipes 414. In this way, the vortexes of the air in the first air channel 11 on a side (e.g. a rear side) of the second row of liquid condensing pipes 414 away from the first row of liquid condensing pipes 413 may be reduced, thereby reducing the form drag generated by the vortexes, making the air in the first air channel 11 flow smoothly, thereby reducing the energy consumption of the fan 50.

Moreover, the first liquid condensing sub-pipes 4101 and the third liquid condensing sub-pipes 4103 each may be arranged in a row, and the plurality of first liquid condensing sub-pipes 4101 and the plurality of third liquid condensing sub-pipes 4103 may be located in the same row as the second row of liquid condensing pipes 414. In this case, on the plane where the first direction and the third direction are located, the cross-sectional areas of the liquid condensing pipes 410 in the second row of liquid condensing pipes 414, the cross-sectional areas of the plurality of first liquid condensing sub-pipes 4101, and the cross-sectional areas of the plurality of third liquid condensing sub-pipes 4103 may be same, and the cross-sectional areas of the liquid condensing pipes 410 in the first row of liquid condensing pipes 413 are greater than the cross-sectional areas of the plurality of first liquid condensing sub-pipes 4101, and the cross-sectional areas of the liquid condensing pipes 410 in the first row of liquid condensing pipes 413 are greater than the cross-sectional areas of the plurality of third liquid condensing sub-pipes 4103.

The above is mainly described by considering an example in which the air enters the plurality of liquid condensing pipes 410 from one side of the liquid condensing device 400. Of course, in some embodiments, the air may also enter the liquid condensing pipes 410 through different sides of the liquid condensing device 400.

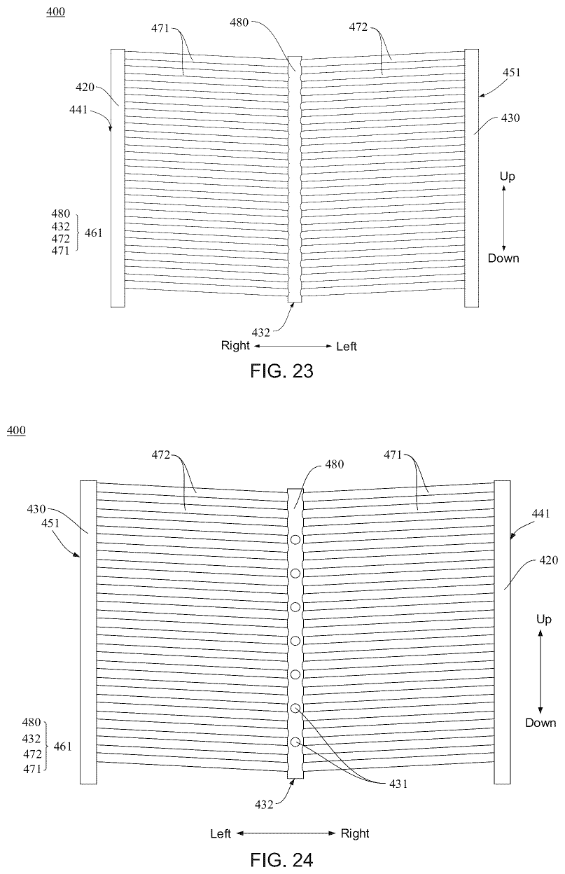

FIG. 22 is a diagram showing yet another structure of a liquid condensing device, in accordance with some embodiments, and the dotted arrows in FIG. 22 indicate a flow direction of the air in the second air channel 12. FIG. 23 is a diagram showing yet another structure of a liquid condensing device, in accordance with some embodiments. FIG. 24 is a diagram showing yet another structure of a liquid condensing device, in accordance with some embodiments.

As shown in FIGS. 22 to 24, the liquid condensing device 400 includes a body 461, a first air inlet cavity 441, and a second air inlet cavity 451. The first air inlet cavity 441 and the second air inlet cavity 451 are disposed on different sides of the body 461 and communicated with the body 461. The air in the first air channel 11 passes through the outer surface of the evaporator 200, an outer surface of the liquid condensing device 400, and the outer surface of the condenser 300 in sequence, and the air in the second air channel 12 passes through the first air inlet cavity 441 and the second air inlet cavity 451 and flows through the inside of the body 461 and the outer surface of the condenser 300 in sequence.

For example, as shown in FIG. 24, the first air inlet cavity 441 and the second air inlet cavity 451 are disposed on two sides (e.g., left and right sides) of the body 461 in the second direction.

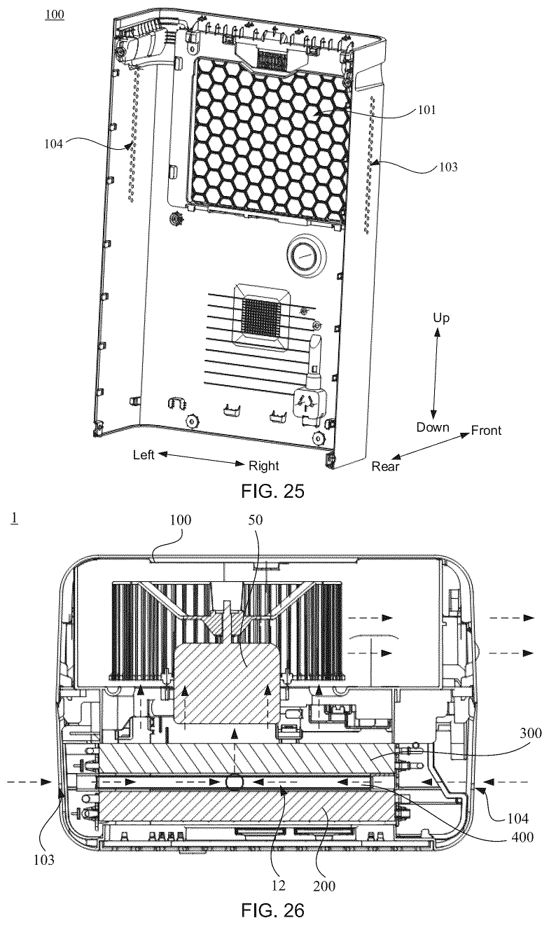

FIG. 25 is a diagram showing a structure of a housing, in accordance with some embodiments. FIG. 26 is a diagram showing another structure of a second air channel in a dehumidifier, in accordance with some embodiments.

In this case, as shown in FIGS. 25 and 26, in addition to the main air inlet 101, the housing 100 is further provided with a first air inlet 103 and a second air inlet 104. The first air inlet 103 and the second air inlet 104 are communicated with the second air channel 12, and the first air inlet 103 corresponds to and is proximate to the first air inlet cavity 441, and the second air inlet 104 corresponds to and is proximate to the second air inlet cavity 451.

For the detailed flow direction of the air in the first air channel 11, reference may be made to the relevant content described above, which will not be repeated herein. As shown in FIG. 26, regarding the flow direction of the air in the second air channel 12, a part of the indoor air may enter the housing 100 through the first air inlet 103 and flow to the first air inlet cavity 441 and then enter the body 461 through the first air inlet cavity 441. A part of the indoor air may enter the housing 100 through the second air inlet 104 and flow to the second air inlet cavity 451 and then enter the body 461 through the second air inlet cavity 451. In this case, the low temperature air passing through the evaporator 200 flows through the outer surface of the body 461 and performs heat exchange with the air in the body 461, so that moisture in the air in the body 461 condenses into condensed water, thereby achieving the dehumidification for the air in the second air channel 12. Afterwards, the dehumidified air is heated by the condenser 300, which further reduces the humidity of the air, so that the air becomes dry air with moderate temperature and flows into the indoor environment, thereby completing the dehumidification for the indoor air.

In some embodiments, the first air inlet cavity 441 and the second air inlet cavity 451 may be symmetrically arranged with respect to a center plane of the liquid condensing device 400 in the second direction, so as to simplify the structure of the liquid condensing device 400, which is conducive to processing the liquid condensing device 400. In this way, the air inlet structures of the liquid condensing device 400 in the second direction are same, and the air uniformly enters the liquid condensing device 400.

In some embodiments of the present disclosure, the air volume of the air entering the liquid condensing device 400 may be increased by providing the plurality of air inlet cavities. In this way, the low temperature air in the first air channel 11 may perform heat exchange with a large amount of air in the liquid condensing device 400, thereby improving the utilization of the coldness of the low temperature air passing through the evaporator 200, thereby improving the dehumidification amount of the dehumidifier 1. Air may enter first air inlet cavity 441 and the second air inlet cavity 451 simultaneously, which may increase the air volume of the air entering the liquid condensing device 400.

A distance between the first air inlet cavity 441 and the second air inlet cavity 451 may be increased by providing the first air inlet cavity 441 and the second air inlet cavity 451 on two sides of the body 461 in the second direction. In this way, the air entering the first air inlet cavity 441 and the air entering the second air inlet cavity 451 will not interfere with each other, so that the air enters the first air inlet cavity 441 and the second air inlet cavity 451 smoothly.

In addition, the air volume of the air entering the first air inlet cavity 441 and the second air inlet cavity 451 and the air volume in the second air channel 12 may be increased by providing the first air inlet 103 and the second air inlet 104 corresponding to the first air inlet cavity 441 and the second air inlet cavity 451 respectively, thereby improving the dehumidification efficiency of the dehumidifier 1.

In some embodiments, as shown in FIG. 24, the liquid condensing device 400 further includes a first exhaust hole 431. The first exhaust hole 431 is disposed on the body 461 and communicated with the first air inlet cavity 441 and the second air inlet cavity 451. The air flowing into the body 461 may flow to the outer surface of the condenser 300 from the first exhaust hole 431. In this way, the air discharged from the first exhaust hole 431 may be mixed with the air in the first air channel 11 on the side (e.g., the front side) of the condenser 300 proximate to the evaporator 200. The mixed air flows to the condenser 300 to perform heat exchange with the condenser 300, and the air heated by the condenser 300 may be changed into dry air with moderate temperature and flow back to the indoor environment. Of course, in some embodiments, the liquid condensing device 400 may include a plurality of first exhaust holes 431.

In some embodiments, as shown in FIGS. 22 to 24, the body 461 includes a first liquid condensing pipe 471 and a second liquid condensing pipe 472, and the first liquid condensing pipe 471 and the second liquid condensing pipe 472 are arranged in the second direction. A first end of the first liquid condensing pipe 471 is communicated with the first air inlet cavity 441, and a second end of the first liquid condensing pipe 471 is communicated with the first exhaust hole 431. A first end of the second liquid condensing pipe 472 is communicated with the second air inlet cavity 451, and a second end of the second liquid condensing pipe 472 is communicated with the first exhaust hole 431.

The air in the second air channel 12 has two flow paths. In one flow path, the air flows through the first air inlet cavity 441, the first liquid condensing pipe 471, and the first exhaust hole 431 in sequence, and flows to the condenser 300 through the first exhaust hole 431. In another flow path, the air flows through the second air inlet cavity 451, the second liquid condensing pipe 472, and the first exhaust hole 431 in sequence, and flows to the condenser 300 through the first exhaust hole 431. The flow rate of the air in the second air channel 12 may be increased by providing the plurality of flow paths, thereby improving the dehumidification efficiency of the dehumidifier 1.

In some embodiments, as shown in FIGS. 22 to 24, the first liquid condensing pipe 471 is inclined downward in a direction (e.g. the second direction) from the first air inlet cavity 441 to the second air inlet cavity 451, and the second liquid condensing pipe 472 is inclined downward in a direction (e.g., an opposite direction of the second direction) from the second air inlet cavity 451 to the first air inlet cavity 441.

In this case, the first end of the first liquid condensing pipe 471 proximate to the first air inlet 103 is higher than the second end of the first liquid condensing pipe 471 away from the first air inlet 103, and the first end of the second liquid condensing pipe 472 proximate to the second air inlet 104 is higher than the second end of the second liquid condensing pipe 472 away from the second air inlet 104. In this way, condensed water in the first liquid condensing pipe 471 and the second liquid condensing pipe 472 may flow quickly due to the action of gravity, which prevents condensed water from accumulating in the first liquid condensing pipe 471 and the second liquid condensing pipe 472, so that condensed water may be quickly discharged from the liquid condensing device 400.

For example, a slope of the first liquid condensing pipe 471 and a slope of the second liquid condensing pipe 472 are greater than a second preset value (e.g., 3%). In this way, the first liquid condensing pipe 471 and the second liquid condensing pipe 472 have large slopes and have large inclined angles with respect to a horizontal plane. Condensed water in the first liquid condensing pipe 471 and the second liquid condensing pipe 472 may flow quickly due to the action of gravity, which prevents condensed water from accumulating in the first liquid condensing pipe 471 and the second liquid condensing pipe 472, so that condensed water may be quickly discharged from the liquid condensing device 400.

In some embodiments, as shown in FIGS. 22 to 24, the body 461 further includes an air collecting pipe 480, a drainage hole 432, and the liquid condensing device 400 further includes a first support plate 420 and a second support plate 430.

The air collecting pipe 480 is connected to and communicated with the second end of the first liquid condensing pipe 471 and the second end of the second liquid condensing pipe 472. The first exhaust hole 431 is disposed on a side (e.g., a rear side) of the air collecting pipe 480 proximate to the condenser 300. The drainage hole 432 is disposed at a bottom of the air collecting pipe 480, so as to discharge condensed water. The first support plate 420 and the second support plate 430 are arranged at two ends of the body 461, respectively. The first air inlet cavity 441 is disposed on the first support plate 420. For example, a side of the first support plate 420 away from the body 461 is recessed, so as to form the first air inlet cavity 441. The first end of the first liquid condensing pipe 471 is connected to a bottom wall of the first air inlet cavity 441. The second air inlet cavity 451 is disposed on the second support plate 430. For example, a side of the second support plate 430 away from the body 461 is recessed, so as to form the second air inlet cavity 451. The first end of the second liquid condensing pipe 472 is connected to a bottom wall of the second air inlet cavity 451. The first support plate 420 and the second support plate 430 are arranged at an interval in the second direction.

In this case, moisture in the air in the second air channel 12 may condense in the first liquid condensing pipe 471 and the second liquid condensing pipe 472, and the condensed air may flow to the air collecting pipe 480 and flow to the condenser 300 through the first exhaust hole 431 of the air collecting pipe 480. Moreover, condensed water in the first liquid condensing pipe 471 and the second liquid condensing pipe 472 may be discharged from the drainage hole 432 of the air collecting pipe 480, so as to prevent condensed water from accumulating in the first liquid condensing pipe 471, the second liquid condensing pipe 472, and the air collecting pipe 480.

It will be noted that the first end of the first liquid condensing pipe 471 may be communicated with the first air inlet cavity 441 on the first support plate 420, and the air in the second air channel 12 may enter the first liquid condensing pipe 471 through the first air inlet cavity 441, which prevents the first support plate 420 from blocking the first liquid condensing pipe 471, so that the air may enter the first liquid condensing pipe 471 smoothly. The first end of the second liquid condensing pipe 472 may be communicated with the second air inlet cavity 451 on the second support plate 430, and the air in the second air channel 12 may enter the second liquid condensing pipe 472 through the second air inlet cavity 451, which prevents the second support plate 430 from blocking the second liquid condensing pipe 472, so that the air may enter the second liquid condensing pipe 472 smoothly. In this way, the uniformity of the air entering the first liquid condensing pipe 471 and the air entering the second liquid condensing pipe 472 may be improved.

In some embodiments, the inside of the air collecting pipe 480 may be a hollow structure, or may be provided with fillers. In a case where the inside of the air collecting pipe 480 is a hollow structure, the air has little flow resistance in the air collecting pipe 480, thereby reducing the energy consumption of the fan 50. In a case where fillers are disposed inside the air collecting pipe 480, the flow velocity of the air in the air collecting pipe 480 is reduced, so as to increase the heat exchange time between the air in the air collecting pipe 480 and the low temperature air in the first air channel 11 and increase the heat exchange amount, so that the dehumidification effect of the dehumidifier 1 and the dehumidification efficiency of the dehumidifier 1 are improved. Of course, the inner structure of the air collecting pipe 480 may be set according to the configuration of the dehumidifier 1.

In some embodiments, an inner diameter of the air collecting pipe 480 is greater than an inner diameter of the first liquid condensing pipe 471 and an inner diameter of the second liquid condensing pipe 472. In this way, the air in the air collecting pipe 480 has little flow resistance, so as to increase the air volume of the air flowing out of the liquid condensing device 400 and improve the flow velocity of the air in the air collecting pipe 480, thereby reducing the energy consumption of the fan 50 and reducing the cost.

In some embodiments, as shown in FIGS. 22 to 24, the air collecting pipe 480 extends in the third direction. In a case where the liquid condensing device 400 includes the plurality of first exhaust holes 431, any two adjacent first exhaust holes 431 of the plurality of first exhaust holes 431 are disposed on the air collecting pipe 480 at an interval in the third direction. A distance between any one of the plurality of first exhaust holes 431 and a first end (e.g., an upper end) of the air collecting pipe 480 away from the drainage hole 432 is greater than a distance between the first exhaust hole 431 and a second end (e.g., a lower end) of the air collecting pipe 480 proximate to the drainage hole 432. The upper end of the air collecting pipe 480 may be closed.

In this case, positions of the plurality of first exhaust holes 431 are proximate to the lower end of the air collecting pipe 480. In this way, a stay time of the air passing through the first liquid condensing pipe 471 and the second liquid condensing pipe 472 in the air collecting pipe 480 may be increased, so as to increase the heat exchange time between the air in the second air channel 12 and the air in the first air channel 11 and increase the heat exchange amount, thereby improving the dehumidification efficiency of the dehumidifier 1.

Of course, in some embodiments, the plurality of first exhaust holes 431 may also be spaced apart from each other in an extending direction of the air collecting pipe 480, so as to simplify the structure of the air collecting pipe 480 and facilitate processing. Moreover, the air may flow out of the air collecting pipe 480 uniformly, thereby increasing the air volume of the air flowing out of the air collecting pipe 480. In this way, most of the air in the second air channel 12 may perform sufficient heat exchange with the condenser 300 after passing through the liquid condensing device 400.

The above is mainly described by considering an example in which the air collecting pipe 480 extends in the third direction. Of course, in some embodiments, the air collecting pipe 480 may also extend in other directions.

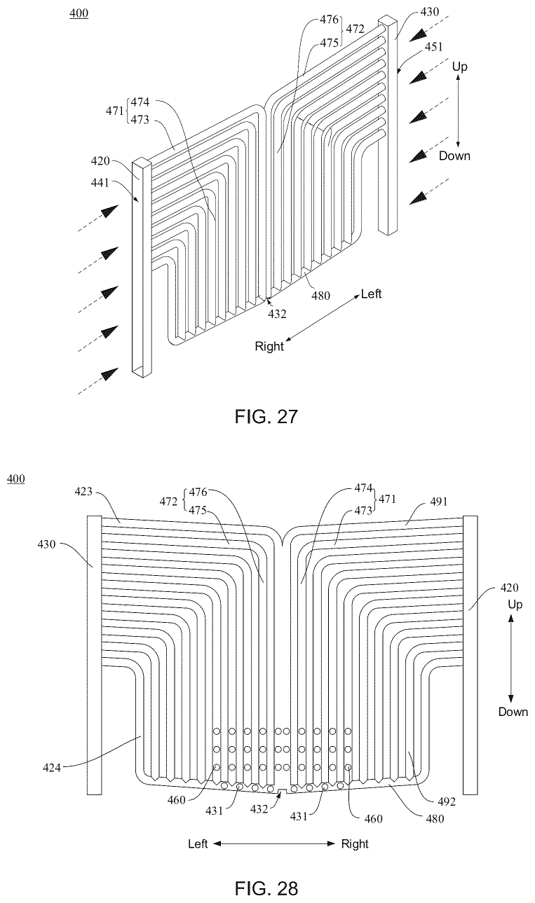

FIG. 27 is a diagram showing yet another structure of a liquid condensing device, in accordance with some embodiments. FIG. 28 is a diagram showing yet another structure of a liquid condensing device, in accordance with some embodiments.

As shown in FIGS. 27 and 28, the air collecting pipe 480 extends in the second direction, and the drainage hole 432 is located at a center of the air collecting pipe 480 in the second direction. In a case where the liquid condensing device 400 includes the plurality of first exhaust holes 431, a distance between any one of the plurality of first exhaust holes 431 and a center of an extending direction of the air collecting pipe 480 is less than distances between the first exhaust hole 431 and two ends of the air collecting pipe 480 away from the drainage hole 432. Here, the two ends of the air collecting pipe 480 may be closed.

In this way, the plurality of first exhaust holes 431 may be proximate to the center of the extending direction of the air collecting pipe 480, and the air discharged from the plurality of first exhaust holes 431 may flow to a central portion of the condenser 300, thereby improving the heat exchange efficiency between the air in the second air channel 12 and the condenser 300. Moreover, there is a long heat exchange time between the air in the body 461 and the air in the first air channel 11, and the air in the body 461 may perform sufficient heat exchange with the air in the first air channel 11, thereby improving the dehumidification efficiency of the dehumidifier 1.

In some embodiments, a distance between the drainage hole 432 and the first liquid condensing pipe 471 may be the same as a distance between the drainage hole 432 and the second liquid condensing pipe 472, so that discharging rates of condensed water in the first liquid condensing pipe 471 and the second liquid condensing pipe 472 are substantially same.

In some embodiments, as shown in FIGS. 27 and 28, the air collecting pipe 480 is inclined upward from a center of its length to its end portions. The air collecting pipe 480 is inclined upward in any direction (e.g., from right to left, or from left to right) from the center of the extending direction of the air collecting pipe 480 to the two ends of the air collecting pipe 480, so that the two ends of the air collecting pipe 480 in the extending direction thereof are higher than the center of the air collecting pipe 480. In this way, the drainage hole 432 may be located at the lowest position of the air collecting pipe 480, and condensed water in the air collecting pipe 480 may flow quickly due to the action of gravity, which prevents condensed water from accumulating in the air collecting pipe 480, so that condensed water may be quickly discharged from the liquid condensing device 400, and the air in the air collecting pipe 480 may also flow quickly to the first exhaust holes 431, and the air flows smoothly.

In some embodiments, as shown in FIGS. 27 and 28, the first liquid condensing pipe 471 includes a first liquid condensing portion 473 and a second liquid condensing portion 474. The first liquid condensing portion 473 is inclined downward in the second direction (from right to left), so that a first end (e.g., a right end) of the first liquid condensing portion 473 proximate to the first air inlet cavity 441 is higher than a second end (e.g., a left end) of the first liquid condensing portion 473 away from the first air inlet cavity 441. The right end of the first liquid condensing portion 473 is communicated with the first air inlet cavity 441. The second liquid condensing portion 474 extends in the third direction, and a first end (e.g., an upper end) of the second liquid condensing portion 474 away from the air collecting pipe 480 is communicated with the second end of the first liquid condensing portion 473, and a second end (e.g., a lower end) of the second liquid condensing portion 474 proximate to the air collecting pipe 480 is communicated with the air collecting pipe 480.

The second liquid condensing pipe 472 includes a third liquid condensing portion 475 and a fourth liquid condensing portion 476. The third liquid condensing portion 475 is inclined downward in the opposite direction (e.g., from left to right) of the second direction, so that a first end (e.g., a left end) of the third liquid condensing portion 475 proximate to the second air inlet cavity 451 is higher than a second end (e.g., a right end) of the third liquid condensing portion 475 away from the second air inlet cavity 451. The left end of the third liquid condensing portion 475 is communicated with the second air inlet cavity 451. The fourth liquid condensing portion 476 extends in the third direction, and a first end (e.g., an upper end) of the fourth liquid condensing portion 476 away from the air collecting pipe 480 is communicated with the second end of the third liquid condensing portion 475, and a second end (e.g., a lower end) of the fourth liquid condensing portion 476 proximate to the air collecting pipe 480 is communicated with the air collecting pipe 480.

In this case, the first liquid condensing pipe 471 and the second liquid condensing pipe 472 have long lengths. In this way, a time that the air in the first liquid condensing pipe 471 flows in the first liquid condensing pipe 471 and a time that the air in the second liquid condensing pipe 472 flows in the second liquid condensing pipe 472 may be increased, so that the heat exchange time between the air in the first liquid condensing pipe 471 and the second liquid condensing pipe 472 and the low temperature air in the first air channel 11 is increased, thereby improving the heat exchange efficiency of the liquid condensing device 400 and the dehumidification efficiency of the dehumidifier 1.

The principle and beneficial effect of the inclined first liquid condensing portion 473 and the inclined third liquid condensing portion 475 are substantially the same as the principle and beneficial effect of the inclined liquid condensing pipe 410 described above, which will not be repeated herein.

In some embodiments, as shown in FIG. 28, the body 461 includes a plurality of first liquid condensing pipes 471, and the plurality of first liquid condensing pipes 471 include a first pipe 491 and a second pipe 492. The first liquid condensing portion 473 of the first pipe 491 is located on a side (e.g., an upper side) of the first liquid condensing portion 473 of the second pipe 492 away from the air collecting pipe 480, and the second liquid condensing portion 474 of the first pipe 491 is located on a side (e.g., a left side) of the second liquid condensing portion 474 of the second pipe 492 away from the first air inlet cavity 441.

The body 461 includes a plurality of second liquid condensing pipes 472, and the plurality of second liquid condensing pipes 472 include a third pipe 423 and a fourth pipe 424. The third liquid condensing portion 475 of the third pipe 423 is located on a side (e.g., an upper side) of the third liquid condensing portion 475 of the fourth pipe 424 away from the air collecting pipe 480, and the fourth liquid condensing portion 476 of the third pipe 423 is located on a side (e.g., a right side) of the fourth liquid condensing portion 476 of the fourth pipe 424 away from the second air inlet cavity 451.

In this way, the first pipe 491 and the second pipe 492 are arranged regularly, and the first pipe 491 and the second pipe 492 are arranged at an interval, so as to avoid crossing each other, so that the air in the first liquid condensing pipes 471 flows smoothly. Moreover, the third pipe 423 and the fourth pipe 424 are arranged regularly, and the third pipe 423 and the fourth pipe 424 are arranged at an interval, so as to avoid crossing each other, so that the air in the second liquid condensing pipes 472 flows smoothly.

In some embodiments, a size of the first liquid condensing pipe 471 in the third direction, a size of the second liquid condensing pipe 472 in the third direction, a length of the first support plate 420 in the third direction, and a length of the second support plate 430 in the third direction may be substantially same. In this way, in an aspect, it is possible to prevent the first liquid condensing pipes 471 and the second liquid condensing pipes 472 from exceeding the first support plate 420 and the second support plate 430, and the first support plate 420 and the second support plate 430 may protect the first liquid condensing pipes 471 and the second liquid condensing pipes 472. In another aspect, it is possible to prevent the lengths of the first liquid condensing pipes 471 and the second liquid condensing pipes 472 from being too short, and the air in the second air channel 12 may flow in the first liquid condensing pipes 471 and the second liquid condensing pipes 472 for a long time, thereby improving the dehumidification effect of the liquid condensing device 400.

In some embodiments, as shown in FIG. 28, the body 461 further includes a plurality of third exhaust holes 460. The plurality of third exhaust holes 460 are disposed at an end (e.g., a lower end) of the first pipe 491 proximate to the air collecting pipe 480 and at an end (e.g., a lower end) of the third pipe 423 proximate to the air collecting pipe 480. The plurality of third exhaust holes 460 are located on sides (e.g., rear sides) of the first liquid condensing pipes 471 or the second liquid condensing pipes 472 proximate to the condenser 300.

Since the length of the first pipe 491 is greater than that of the second pipe 492, and the length of the third pipe 423 is greater than that of the fourth pipe 424, there is a lot of air in the first pipe 491 and the third pipe 423. By providing the plurality of third exhaust holes 460, the air in the long liquid condensing pipes (e.g., the first pipe 491 and the third pipe 423) may be discharged from the corresponding third exhaust holes 460, which improves the air supply efficiency of the first pipe 491 and the third pipe 423, so that the flow resistance of the air in the first pipe 491, the second pipe 492, the third pipe 423, and the fourth pipe 424 may be substantially same, thereby increasing the air volume of the air flowing out of the second air channel 12.

In some embodiments, corners of inner walls of the first air inlet cavity 441 and the second air inlet cavity 451 may be rounded corners. For example, a cross section of the first air inlet cavity 441 or the second air inlet cavity 451 is in a shape of a rectangle, and corners of the rectangle are in a shape of an arc. For the function and effect of the rounded corner structure, reference may be made to the relevant content described above, which will not be repeated herein.

In some embodiments, a cross section of the first liquid condensing pipe 471 and a cross section of the second liquid condensing pipe 472 may be in a shape of at least one of a circle, an ellipse, or a water drop.

In some embodiments, the plurality of first liquid condensing pipes 471 and the plurality of second liquid condensing pipes 472 may be arranged in a row in the third direction. Alternatively, the plurality of first liquid condensing pipes 471 may be arranged in a plurality of rows in the first direction, and the plurality of second liquid condensing pipes 472 may be arranged in a plurality of rows in the first direction. Moreover, in the first direction, the first liquid condensing pipes 471 in the plurality of rows of first liquid condensing pipes 471 may be aligned with each other, and the second liquid condensing pipes 472 in the plurality of rows of second liquid condensing pipes 472 may be aligned with each other. Alternatively, at least two rows of first liquid condensing pipes 471 in the plurality of rows of first liquid condensing pipes 471 are separated from each other, and at least two rows of second liquid condensing pipes 472 in the plurality of rows of second liquid condensing pipes 472 are separated from each other.

In some embodiments, the first liquid condensing pipes 471 and the second liquid condensing pipes 472 may be metal pipes (e.g., copper tubes). There is a hydrophobic layer on an inner wall of the liquid condensing pipe 410. The hydrophobic layer may be a coating of a compound (e.g., fluorosilane polymer) with hydrophobicity. For the function and effect of the hydrophobic layer, reference may be made to the relevant content described above, which will not be repeated herein. Of course, the first liquid condensing pipes 471 and the second liquid condensing pipes 472 may also be made of a material having a high condensation heat transfer coefficient such as vinylidene fluoride.

In some embodiments, as shown in FIGS. 3 and 4, the dehumidifier 1 further includes a water collecting member 470 (also referred to as a water collecting tray). The water collecting member 470 is disposed in the housing 100 and located at bottoms of the evaporator 200, the condenser 300, and the liquid condensing device 400. The water collecting member 470 is configured to hold condensed water generated by the evaporator 200, the condenser 300, and the liquid condensing device 400. In this case, condensed water on the outer surface of the evaporator 200 and condensed water in the liquid condensing device 400 may drip into the water collecting member 470 in a direction (downward) proximate to the water collecting member 470. In this way, the water collecting member 470 may collect condensed water and prevent condensed water from flowing to other components of the dehumidifier 1, thereby preventing condensed water from contaminating other components of the dehumidifier 1. In some embodiments, as shown in FIG. 3, the water collecting member 470 includes a water collecting tank, and the dehumidifier 1 further includes a water storage tank 60. The water collecting tank is communicated with the water storage tank 60, and the water storage tank 60 may be located on a side (e.g., a lower side) of the water collecting member 470 away from the liquid condensing device 400.

In the above description of the embodiments, specific features, structures, materials, or characteristics may be combined in a suitable manner in any one or more embodiments or examples.

It will be noted that any one of the technical solutions disclosed in the present disclosure may solve one or more of the technical problems described above and achieve certain disclosure purposes to a certain extent; a plurality of disclosed technical solutions may also be combined into an overall solution, so as to solve one or more of the technical problems described above and achieve certain disclosure purposes; some disclosed technical disclosures may also be selected to be combined into an overall solution, while adopting the related art and deteriorated solutions, but the deterioration trend may be compensated by the means of the present technical disclosure, and one or more of the technical problems described above may be solved to a certain extent as a whole and certain disclosure purposes may be achieved to a certain extent as a whole; and each technical disclosure combined into a complete technical solution constitutes an organic and inseparable overall solution, which solves technical problems as a whole and achieves certain disclosure purposes.

Any technical disclosure in the present disclosure, as well as the recombination of the plurality of technical disclosures, may form a complete technical solution and may solve one or more of the technical problems described above and achieve the purpose of the present disclosure. They all belong to the content of the present disclosure and belong to the content that is directly and unambiguously determined according to the content of the present disclosure.

A person skilled in the art will understand that the scope of disclosure in the present disclosure is not limited to specific embodiments discussed above and may modify and substitute some elements of the embodiments without departing from the spirits of the present disclosure. The scope of the present disclosure is limited by the appended claims.

What is claimed is:

1. A dehumidifier, comprising:
a housing, a first air channel and a second air channel being disposed in the housing;
an evaporator disposed in the housing;
a condenser disposed in the housing, the evaporator and the condenser being arranged in sequence in a first direction and located in the first air channel;
a liquid condensing device disposed in the housing and located between the evaporator and the condenser, the liquid condensing device including a plurality of liquid condensing pipes, the plurality of liquid condensing pipes extending in a second direction and being communicated with the second air channel, the plurality of liquid condensing pipes being located in a first region, a second region, and a third region, the first region, the second region, and the third region being arranged in sequence in a third direction, the first direction, the second direction, and the third direction being perpendicular to each other, a contact area between two or more liquid condensing pipes in the second region and air in the first air channel being greater than a contact area between two or more liquid condensing pipes in the first region, and the contact area between two or more liquid condensing pipes in the second region and air in the first air channel being greater than the air in the first air channel and a contact area between two or more liquid condensing pipes in the third region and the air in the first air channel; and
a fan disposed in the housing and located on a side of the condenser away from the evaporator, the air in the first air channel passing through the evaporator, outer surfaces of the plurality of liquid condensing pipes, and the condenser in sequence, and then entering the fan and being discharged from the dehumidifier by the fan; and the air in the second air channel passing through an inner space of the plurality of liquid condensing pipes and the condenser in sequence, and then entering the fan and being discharged from the dehumidifier by the fan.

2. The dehumidifier according to claim 1, wherein a distance between the two adjacent liquid condensing pipes in the second region is less than a distance between the two adjacent liquid condensing pipes in the first region, and the distance between the two adjacent liquid condensing pipes in the second region is less than a distance between the two adjacent liquid condensing pipes in the third region.

3. The dehumidifier according to claim 2, wherein the liquid condensing device satisfies at least one of following:
the second region has a first center plane, the first center plane is located in a center of the second region and perpendicular to the third direction, and among the two or more liquid condensing pipes in the second region, the distance between the two adjacent liquid condensing pipes away from the first center plane is greater than the distance between the two adjacent liquid condensing pipes proximate to the first center plane;
or
the second region has the first center plane, the first center plane is located in the center of the second region and perpendicular to the third direction, and the two or more liquid condensing pipes in the second region are symmetrically disposed with respect to the first center plane.

4. The dehumidifier according to claim 1, wherein on a plane where the first direction and the third direction are located, a cross-sectional area of any one of the two or more liquid condensing pipes in the second region is greater than a cross-sectional area of any one of the two or more liquid condensing pipes in the first region, and the cross-sectional area of any one of the two or more liquid condensing pipes in the second region is greater than a cross-sectional area of any one of the two or more liquid condensing pipes in the third region.

5. The dehumidifier according to claim 4, wherein the liquid condensing device satisfies at least one of following:
in the first direction, sides of the liquid condensing pipes in the first region proximate to the condenser, sides of the liquid condensing pipes in the second region proximate to the condenser, and sides of the liquid condensing pipes in the third region proximate to the condenser are located on a same plane;
or
in the first direction, sides of the liquid condensing pipes in the second region proximate to the evaporator are closer to the evaporator than sides of the liquid condensing pipes in the first region proximate to the evaporator, and the sides of the liquid condensing pipes in the second region proximate to the evaporator are closer to the evaporator than sides of the liquid condensing pipes in the third region proximate to the evaporator.

6. The dehumidifier according to claim 1, wherein in the first direction, a number of rows of the two or more liquid condensing pipes in the second region is greater than a number of rows of the two or more liquid condensing pipes in the first region, and the number of rows of the two or more liquid condensing pipes in the second region is greater than a number of rows of the two or more liquid condensing pipes in the third region.

7. The dehumidifier according to claim 6, wherein the two or more liquid condensing pipes in the second region are arranged in two rows in the first direction, and in the two rows of liquid condensing pipes, a row of liquid condensing pipes proximate to the evaporator is a first row of liquid condensing pipes, and another row of liquid condensing pipes away from the evaporator is a second row of liquid condensing pipes;
the first row of liquid condensing pipes and the second row of liquid condensing pipes are sequentially arranged in the first direction, and a number of the liquid condensing pipes in the first row of liquid condensing pipes and a number of the liquid condensing pipes in the second row of liquid condensing pipes are same, the liquid condensing pipes in the first row of liquid condensing pipes correspond to the liquid condensing pipes in the second row of liquid condensing pipes, respectively, and the liquid condensing pipes in the first row of liquid condensing pipes and the corresponding liquid condensing pipes in the second row of liquid condensing pipes are at a same height; and
on a plane where the first direction and the third direction are located, a cross-sectional area of any liquid condensing pipe in the first row of liquid condensing pipes is greater than a cross-sectional area of any liquid condensing pipe in the second row of liquid condensing pipes.

8. The dehumidifier according to claim 1, wherein the liquid condensing device satisfies at least one of following:
a distance between the two adjacent liquid condensing pipes in the first region is equal to a distance between the two adjacent liquid condensing pipes in the third region;
or
a number of the liquid condensing pipes in the first region is equal to a number of the liquid condensing pipes in the third region.

9. The dehumidifier according to claim 1, wherein at least one of the plurality of liquid condensing pipes includes an air inlet end and an air outlet end, the air in the second air channel flows into the liquid condensing pipe from the air inlet end and flows out of the liquid condensing pipe from the air outlet end, and the liquid condensing device satisfies at least one of following:
the air in the second air channel flows out from the air outlet end and is mixed with the air in the first air channel on a side of the condenser proximate to the evaporator;
or
in a direction from the air inlet end to the air outlet end, the liquid condensing pipe is inclined downward, so that the air inlet end is higher than the air outlet end.

10. The dehumidifier according to claim 1, wherein the liquid condensing device further includes:
a first support plate provided with a first air inlet cavity communicated with the plurality of liquid condensing pipes, first ends of the plurality of liquid condensing pipes being connected to a bottom wall of the first air inlet cavity; and
a second support plate, second ends of the plurality of liquid condensing pipes being connected to the second support plate, and the second ends of the plurality of liquid condensing pipes running through the second support plate.

11. The dehumidifier according to claim 10, wherein the liquid condensing device satisfies at least one of following:
in the third direction, a length of the first support plate is greater than a length of the second support plate, and a second center plane of the first support plate coincides with a third center plane of the second support plate;
or
in the first direction, a width of the first support plate is greater than a width of the second support plate, and a fourth center plane of the first support plate coincides with a fifth center plane of the second support plate;
or
corners of an inner wall of the first air inlet cavity are rounded corners;
or
the second ends of the plurality of liquid condensing pipes and a side of the second support plate away from the first support plate are located on a same plane.

12. The dehumidifier according to claim 1, further comprising:
a water collecting member disposed in the housing and located at bottoms of the evaporator, the condenser, and the liquid condensing device.

13. A dehumidifier, comprising:
a housing, a first air channel and a second air channel being disposed in the housing;
an evaporator disposed in the housing;
a condenser disposed in the housing, the evaporator and the condenser being arranged in sequence in a first direction and located in the first air channel;
a liquid condensing device disposed in the housing and located between the evaporator and the condenser, the liquid condensing device including:
a body;
a first support plate;
a second support plate, the first support plate and the second support plate being arranged at two ends of the body, respectively;
a first air inlet cavity, a side of the first support plate away from the body being recessed, so as to constitute the first air inlet cavity, the first air inlet cavity being communicated with the second air channel and the body; and
a second air inlet cavity, a side of the second support plate away from the body being recessed, so as to constitute the second air inlet cavity, the second air inlet cavity being communicated with the second air channel and the body; and
a fan disposed in the housing and located on a side of the condenser away from the evaporator, the air in the first air channel passing through the evaporator, an outer surface of the body, and the condenser in sequence, and then entering the fan and being discharged from the dehumidifier by the fan; and the air in the second air channel passing through an inner space of the body and the condenser in sequence through the first air inlet cavity and the second air inlet cavity, and then entering the fan and being discharged from the dehumidifier by the fan.

14. The dehumidifier according to claim 13, wherein the first air inlet cavity and the second air inlet cavity are disposed on two sides of the body in a second direction, respectively, and the second direction is perpendicular to the first direction;
the liquid condensing device further includes at least one first exhaust hole, the first exhaust hole is disposed on the body and communicated with the first air inlet cavity and the second air inlet cavity, and the air flowing into the body flows from the first exhaust hole to an outer surface of the condenser; and
the housing is provided with a first air inlet and a second air inlet, the first air inlet and the second air inlet are communicated with the second air channel, and the first air inlet corresponds to the first air inlet cavity and is proximate to the first air inlet cavity, the second air inlet corresponds to the second air inlet cavity and is proximate to the second air inlet cavity.

15. The dehumidifier according to claim 14, wherein the body includes:
at least one first liquid condensing pipe, a first end of the first liquid condensing pipe being connected to a bottom wall of the first air inlet cavity and communicated with the first air inlet cavity, and a second end of the first liquid condensing pipe being communicated with the first exhaust hole;
at least one second liquid condensing pipe, the first liquid condensing pipe and the second liquid condensing pipe being arranged in the second direction, a first end of the second liquid condensing pipe being connected to a bottom wall of the second air inlet cavity and communicated with the second air inlet cavity, and a second end of the second liquid condensing pipe being communicated with the first exhaust hole;
an air collecting pipe communicated with the second end of the first liquid condensing pipe and the second end of the second liquid condensing pipe, the first exhaust hole being disposed on a side of the air collecting pipe proximate to the condenser; and
a drainage hole disposed at a bottom of the air collecting pipe.

16. The dehumidifier according to claim 15, wherein the air collecting pipe extends in a third direction, the third direction is perpendicular to the first direction and the second direction, the at least one first exhaust hole includes a plurality of first exhaust holes, and a distance between any one of the plurality of first exhaust holes and a first end of the air collecting pipe away from the drainage hole is greater than a distance between the first exhaust hole and a second end of the air collecting pipe proximate to the drainage hole.

17. The dehumidifier according to claim 15, wherein the air collecting pipe extends in the second direction, the drainage hole is located at a center of the air collecting pipe in the second direction, the at least one first exhaust hole includes a plurality of first exhaust holes, and a distance between any one of the plurality of first exhaust holes and the center of the air collecting pipe is less than distances between the first exhaust hole and two ends of the air collecting pipe away from the drainage hole.

18. The dehumidifier according to claim 17, wherein the air collecting pipe is inclined upward in any one of directions from the center of the air collecting pipe to the two ends of the air collecting pipe, so that the two ends of the air collecting pipe are higher than the center of the air collecting pipe.

19. The dehumidifier according to claim 17, wherein
the first liquid condensing pipe includes:
a first liquid condensing portion, the first liquid condensing portion being inclined downward in the second direction, a first end of the first liquid condensing portion proximate to the first air inlet cavity being higher than a second end of the first liquid condensing portion away from the first air inlet cavity, and the first end of the first liquid condensing portion being communicated with the first air inlet cavity; and
a second liquid condensing portion extending in a third direction, a first end of the second liquid condensing portion away from the air collecting pipe being communicated with the second end of the first liquid condensing portion, and a second end of the second liquid condensing portion proximate to the air collecting pipe being communicated with the air collecting pipe, and the third direction being perpendicular to the first direction and the second direction;
the second liquid condensing pipe includes:
a third liquid condensing portion, the third liquid condensing portion being inclined downward in an opposite direction of the second direction, a first end of the third liquid condensing portion proximate to the second air inlet cavity being higher than a second end of the third liquid condensing portion away from the second air inlet cavity, and the first end of the third liquid condensing portion being communicated with the second air inlet cavity; and
a fourth liquid condensing portion extending in the third direction, a first end of the fourth liquid condensing portion away from the air collecting pipe being communicated with the second end of the third liquid condensing portion, and a second end of the fourth liquid condensing portion proximate to the air collecting pipe being communicated with the air collecting pipe.

20. The dehumidifier according to claim 19, wherein
the at least one first liquid condensing pipe includes a plurality of first liquid condensing pipes, and the plurality of first liquid condensing pipes include:
a first pipe; and
a second pipe, the first liquid condensing portion of the first pipe being located on a side of the first liquid condensing portion of the second pipe away from the air collecting pipe, and the second liquid condensing portion of the first pipe being located on a side of the second liquid condensing portion of the second pipe away from the first air inlet cavity;
the at least one second liquid condensing pipe includes a plurality of second liquid condensing pipes, and the plurality of second liquid condensing pipes include:
a third pipe; and
a fourth pipe, the third liquid condensing portion of the third pipe being located on a side of the third liquid condensing portion of the fourth pipe away from the air collecting pipe, and the fourth liquid condensing portion of the third pipe being located on a side of the fourth liquid condensing portion of the fourth pipe away from the second air inlet cavity.
